(19) United States
(12) Patent Application Publication
(10) Pub. No.: US 2012/0054085 A1
(43) Pub. Date: Mar. 1, 2012

(54) Methods and Systems for Providing a Beta Commodity Index

(75) Inventor: Tarik Riviere, New York, NY (US)

(73) Assignee: Barclays Capital Inc., New York, NY (US)

(21) Appl. No.: 13/248,722

(22) Filed: Sep. 29, 2011

Related U.S. Application Data
(63) Continuation of application No. 12/290,600, filed on Oct. 30, 2008, now abandoned.
(60) Provisional application No. 60/986,482, filed on Nov. 8, 2007.
(60) Provisional application No. 60/983,802, filed on Oct. 30, 2007.

(51) Int. Cl. G06Q 40/04

(52) U.S. Cl. 705/37

(57) ABSTRACT

In at least one aspect, the invention comprises a computer-implemented method comprising: electronically receiving data regarding prices of exchange-traded futures contracts on physical commodities; selecting, based on said received data, one or more of said futures contracts to be referenced by a commodity index; identifying, on a periodic basis, one or more deferred futures contracts into which said selected one or more futures contracts will roll; and providing one or more derivative products linked to said commodity index. In at least one aspect, the invention comprises a commodity index that references exchange-traded futures contracts on physical commodities, wherein one or more deferred futures contracts into which the futures contracts will roll are identified on a periodic basis, and wherein said one or more deferred futures contracts are identified based on an effective spot price. In at least one aspect, the invention comprises a derivative product linked to a commodity index.

### CROSS REFERENCE TO RELATED APPLICATIONS

This application claims priority to U.S. Provisional Patent Application No. 60/983,082, filed Oct. 30, 2007, and U.S. Provisional Patent Application No. 60/986,482, filed Nov. 8, 2007. The entire contents of each of those provisional applications are incorporated herein by reference.

### INTRODUCTION

Commodity indices are designed for investors who wish to gain commodity market exposure without getting directly involved with either the physical or commodity futures markets. In general, they have three main inputs.

1. Composition—which commodities are included in the index.

2. Weight—how is each commodity within the index weighted.

3. Roll Mechanics—all commodity indices have to roll or “sell” expiring contracts and “buy” the next to expire. Additional variables are when the roll takes place, over what length of time and into which contracts on the commodity futures curve.

The Lehman Brothers Commodity Index (LBCI) was launched in July 2006. This index comprised twenty commodities that rolled between futures contracts based on a predetermined calendar over the 5th through 9th business days of each month that a roll was due to take place. Each commodity assumed a weight at the beginning of each year that was used to determine the contribution of each commodity's performance with respect to the overall index. While many of the features of LBCI are common to other commodity indices, the innovation in LBCI was the methodology by which the weight (Liquidity Factor) was assigned to each commodity, which was achieved using three year historical daily trading values based on the volume of commodity futures contracts traded.

Pure Beta Commodities Index (PBCI)¹ ¹ Historically, the term “beta” has been used to refer to investment products whose performance is intended to track the performance of a market or asset class as a whole.

Indices such as the LBCI have certain characteristics that can limit their utility. One of these is the fact that these indices are always invested in the nearest commodity futures contract to expire, the so-called prompt month. This prompt month contract experiences considerable volatility as it is being invested in by both commercial investors (commodity producers and consumers) and non-commercial investors such as pension funds, hedge funds and speculators, and also is the contract most sensitive to the drivers of commodity prices. The actions of the non-commercial investors are thought to dilute or pollute the value of the prompt contract as a price signal for the value or spot price of the commodity in question.

The PBCI (comprised in an embodiment of the present invention) is an advance in actively managed indices that attempts to avoid some common problems with prior indices and to provide investors with a more efficient way of commodity investing.

PBCI offers a number of innovations over LBCI and other indices.

1. Roll mechanics.
a. Forward Allocation
   i. Whereas the LBCI and other similar indices always roll from the prompt to the prompt +1, the PBCI determines the (deferred) roll contract algorithmically using software stored in a computer readable medium.
   ii. The software-implemented algorithm uses as inputs the effective spot price based on the futures contracts looking 12 calendar months forward. The contracts applicable for a given month are those derived from the LBCI contract calendar and are known as forward allocations. When the Pure Beta Methodology is applied to a contract that is not included in the LBCI, a determination is made to include relevant months based on ability to invest. The effective spot price is computed by the software as the open interest weighted average price of the contracts applicable within the 12 month forward allocation window.
   iii. An excess return value is derived by the software for each of the 12 forward allocations each day using the LBCI roll calendar.
   iv. An effective spot price return is derived by the software looking back over the previous 3 months of effective spot prices.
   v. A correlation between the effective spot price return and each of the 12 forward allocations is computed by the software each quarter. This value is referred to as the Tracking Mark.
   vi. A forward allocation is selected by the software based upon the relationship between each of the 12 correlations.
   vii. The PBCI software rebalances to the applicable new forward allocation every 3 months on the 22nd of each January, April, July and October and the allocation is rolled into over 10 business days.
b. Commodity Roll
   i. Whereas the LBCI rolls over the 5th-9th LBCI business day, the PBCI rolls over the 1st-10th LBCI business days.

2. Weighting mechanism.
a. Whereas the LBCI software uses the LBCI Liquidity Factor multiplied by the spot price divided by the sum of Liquidity Factors multiplied by spot prices each day to determine the daily weight of each commodity within the LBCI, the PBCI software of an embodiment uses excess return value as the weighting mechanism. Thus, each day the daily weight of a component within PBCI is calculated by the software as the LBCI Liquidity Factor multiplied by the excess return divided by the sum of LBCI Liquidity Factors multiplied by excess returns each day.

As a result, PBCI provides investors with a number of benefits over the traditional commodity indices, such as exposure to the commodity asset class with a more accurate reflection of current supply/demand factors that influence spot prices. The software has proven to be a more efficient way of investing in all commodity markets and allows clients to customize their commodity allocation by applying the weighting of their preference to the Pure Beta sub-indices.

The PBCI technology is superior to other enhanced commodity indices currently available. An embodiment is distinct from prior commodities indices through its rolling methodology.

In one aspect, the invention comprises a computer-implemented method comprising: electronically receiving data regarding prices of exchange-traded futures contracts on physical commodities; selecting, based on said received data, one or more of said futures contracts to be referenced by a commodity index; identifying, on a periodic basis, one or more deferred futures contracts into which said selected one or more futures contracts will roll; and providing one or more derivative products linked to said commodity index.

In one embodiment, the computer implemented method further comprises electronically calculating a daily weight for each of said selected futures contracts. In one embodiment of the computer-implemented method, daily weight is based on one or more excess return values and one or more liquidity factors. In one embodiment of the computer-implemented method, daily weight is based on a product of a liquidity factor and an excess return, divided by a sum of products of liquidity factors and excess returns. In one embodiment of the computer-implemented method, one of said one or more excess return values is derived for each of a plurality of forward allocations. In one embodiment of the computer-implemented method, said one of said one or more excess return value is derived for each of said plurality of forward allocations based on a roll calendar. In one embodiment, the computer implemented method further comprises calculating an effective spot price return. In one embodiment, the computer implemented method further comprises calculating a correlation between said effective spot price return and each of said plurality of forward allocations, to obtain a plurality of correlations, wherein each of said plurality of forward allocations is a quarterly value. In one embodiment, the computer implemented method further comprises calculating a forward allocation based on said plurality of correlations.

In one embodiment of the computer-implemented method, identifying one or more deferred futures contracts into which said selected one or more futures contracts will roll, is based on data comprising an effective spot price.

In one embodiment, the computer implemented method further comprises selecting forward allocations for said selected futures contracts based on data comprising an effective spot price. In one embodiment of the computer-implemented method, the effective spot price is based on futures contracts looking 12 months forward. In one embodiment of the computer-implemented method, the effective spot price is based on an open interest weighted average price of futures contracts within a 12 month forward allocation window.

In one embodiment of the computer-implemented method, said commodities index is a sub-index based on a single commodity. In one embodiment, the computer implemented method further comprises creating a basket of one or more sub-indices, each sub-index based on a single commodity. In one embodiment of the computer-implemented method, the disclosed invention includes a note linked to the basket of sub-indices.

In one aspect, the invention comprises a commodity index that references exchange-traded futures contracts on physical commodities, wherein one or more deferred futures contracts into which said one or more futures contracts will roll are identified on aperiodic basis, and wherein said one or more deferred futures contracts are identified based on an effective spot price.

In one embodiment of the commodity index, a daily weight is calculated for each of said one or more futures contracts. In one embodiment of the commodity index, said daily weight is based on one or more excess return values and one or more liquidity factors. In one embodiment of the commodity index, said daily weight is based on a product of a liquidity factor and an excess return, divided by a sum of products of liquidity factors and excess returns. In one embodiment of the commodity index, one of said one or more excess return values is derived for each of a plurality of forward allocations. In one embodiment of the commodity index, said excess return value is derived for each of said plurality of forward allocations based on a roll calendar. In one embodiment of the commodity index, an effective spot price return is calculated. In one embodiment of the commodity index, a correlation between said effective spot price return and each of said plurality of forward allocations is calculated, to obtain a plurality of correlations, wherein each of said plurality of forward allocations is a quarterly value. In one embodiment of the commodity index, a forward allocation based on said plurality of correlations is calculated.

In one embodiment of the commodity index, forward allocations for said one or more futures contracts are selected based on data comprising an effective spot price. In one embodiment of the commodity index, said effective spot price is based on futures contracts looking 12 months forward. In one embodiment of the commodity index, said effective spot price is based on an open interest weighted average price of futures contracts within a 12 month forward allocation window.

In one embodiment of the commodity index, said commodities index is a sub-index based on a single commodity.

In one aspect, the invention can include a derivative product linked to a commodity index that is based on one or more of the preceding embodiments.

### BRIEF DESCRIPTION OF THE DRAWINGS

FIG. 1 depicts exemplary PBCI Weights as a ratio of LBCI Weights for the Energy Sector.

FIG. 2 depicts exemplary Pure Beta Weights as a ratio of LBCI Weights for the Metals Sector.

FIG. 3 depicts exemplary PBCI Weights as a ratio of LBCI Weights for the Agriculture Sector.

FIG. 4 depicts exemplary Pure Beta Weights as a ratio of LBCI Weights for the Livestock Sector.

FIG. 5 depicts a computer based system for processing data according to an embodiment of the invention.

FIGS. 6 and 7 depict an exemplary illustration of a Forward Allocation selection process.

FIG. 8 depicts performance of an exemplary embodiment of the PBCI versus the LBCI.

FIGS. 9-28 depict hypothetical and actual daily historical levels of single-commodity excess return sub-indices.

FIG. 29 depicts hypothetical daily historical Basket Return based on the hypothetical composite performance of the Index Values for the Component Sub-Indices.

### DETAILED DESCRIPTION

Exemplary embodiments of the present invention are described in detail below.

In an exemplary embodiment, the PBCI provides an objective framework to periodically assess the relevance of the different forward contracts. It attempts to maximize the responsiveness to supply disruptions and minimize the component linked to term structure noise and investment flow distortion. These goals are achieved while still operating within the most liquid part of the relevant commodity futures curves. Negative roll yield is further minimized by utilizing a weightings methodology that naturally under-weights commodities that have been in contango² and over-weights ² Contango is a term used to describe an upward sloping forward curve (as in the normal yield curve). One says that such a forward curve is “in contango.” It is the amount by which the price of a commodity for future delivery is higher than the spot price (the current price at which a particular commodity can be bought or sold at a specified time and place), or by which a far future delivery price is higher than a nearer future delivery. The opposite market condition to contango is known as backwardation. commodities in backwardation on a daily basis. The index rebalances quarterly and thus smoothes out discontinuities within commodities that roll less frequently, such as sugar.

Component Selection and Weighting

The PBCI of an embodiment follows the constituent composition of the Lehman

Brothers Commodity Index.³ ³ For details on the mechanics of the LBCI, see Appendix 4.

Annual LBCI Weights

The annual weights of the various components within the LBCI are determined by the average of the last three years of daily liquidity, which are then used to derive a “Liquidity Factor” (LF). The specific commodity LF is derived from the trailing three-year average dollar value of contracts traded divided by the price as of the close of the second business day of January. The new LFs are rolled during the first roll of the New Year from the fifth through ninth business days.

Daily LBCI Weights

Each day, the LF is multiplied by each commodity's spot price to derive the daily weights of each of the LBCI components.

W_{bi}=* P_{bi}/Σ(LF*P_{bi})_{LBCI}

Where:

W_{bi}=the beginning of day index weight for Commodity

LFᵢ=the Liquidity Factor for Commodity i

P_{bi}=the beginning of day commodity price for Commodity i

Σ(LF* P_{b})_{LBCI}=Sum of (LF * Price_{b}) for each LBCI Component

Therefore, at the beginning of each calendar year the weight of each LBCI component is established but is then allowed to vary with spot price as the year progresses. A commodity experiencing spot price appreciation will attain a greater weight within the overall index, with the converse occurring for commodities with spot price declines. The LBCI then re-weights at the end of each year and the process repeats itself.

Daily LBCI Returns

Index level returns are generated by weighting the commodity level returns (excess or total) of each index constituent by its calculated beginning-of-day weight in that index. These daily index returns are then compounded to generate cumulative returns over periods longer than 1 day.

Annual PBCI Weights

The PBCI inherits the new LFs at the beginning of the year and these are rolled over the same roll window as the LBCI.

Daily PBCI Weights

The daily weighting methodology for the PBCI is derived in a similar manner to the LBCI but instead of using spot prices, it uses excess return. Each day, the LF for each commodity is multiplied by each commodity's excess return to derive the daily weights of each of the LBCI components and the daily returns are generated in a similar manner to the LBCI.

This daily weight value can be calculated as follows:

Wⱼ=LFᵢ * Eᵢ/Σ(LFᵢ*Eᵢ)_{LBCI}

Where: Wⱼ=the daily PBCI weight for Commodity i
LFᵢ=the Liquidity Factor for Commodity i
Eᵢ=the Excess Return Index Value for commodity i.

Σ(LFᵢ * Eᵢ)_{LBCI}=Sum of (LFᵢ * Eᵢ) for each LBCI Component

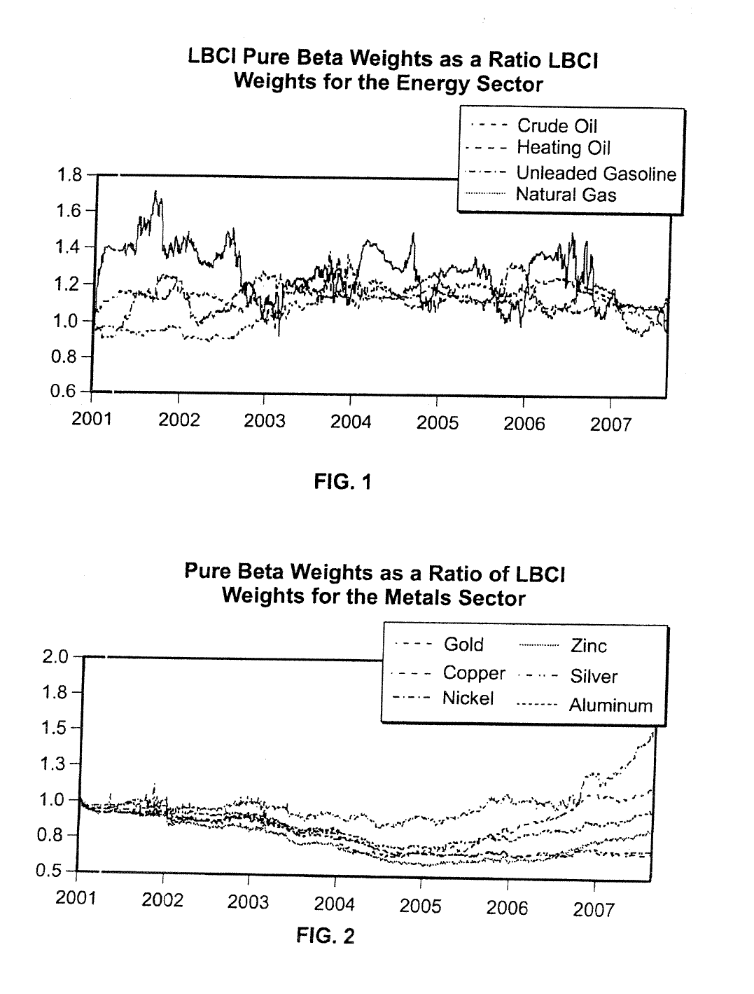

At inception, an embodiment of the PBCI used the Liquidity Factors derived from November 2000 and the daily index weights based on excess returns using the commodity futures contracts established from the October, 2000 Forward Allocation rebalancing (see Appendix 2 fora list of selected definitions). The fact that the weights of the components within the PBCI are not a function of spot prices, but are based upon the excess return of the applicable Forward Allocation means that the weights of the individual components within the PBCI will drift relative to the LBCI. It is precisely this mechanism that results in the increasing weight of commodities in backwardation at the expense of commodities in contango. FIGS. 1-4 indicate the drift in weighting between the PBCI and the LBCI.

FIG. 1 depicts exemplary PBCI Weights as a ratio of LBCI Weights for the Energy Sector.

FIG. 2 depicts exemplary Pure Beta Weights as a ratio of LBCI Weights for the Metals Sector.

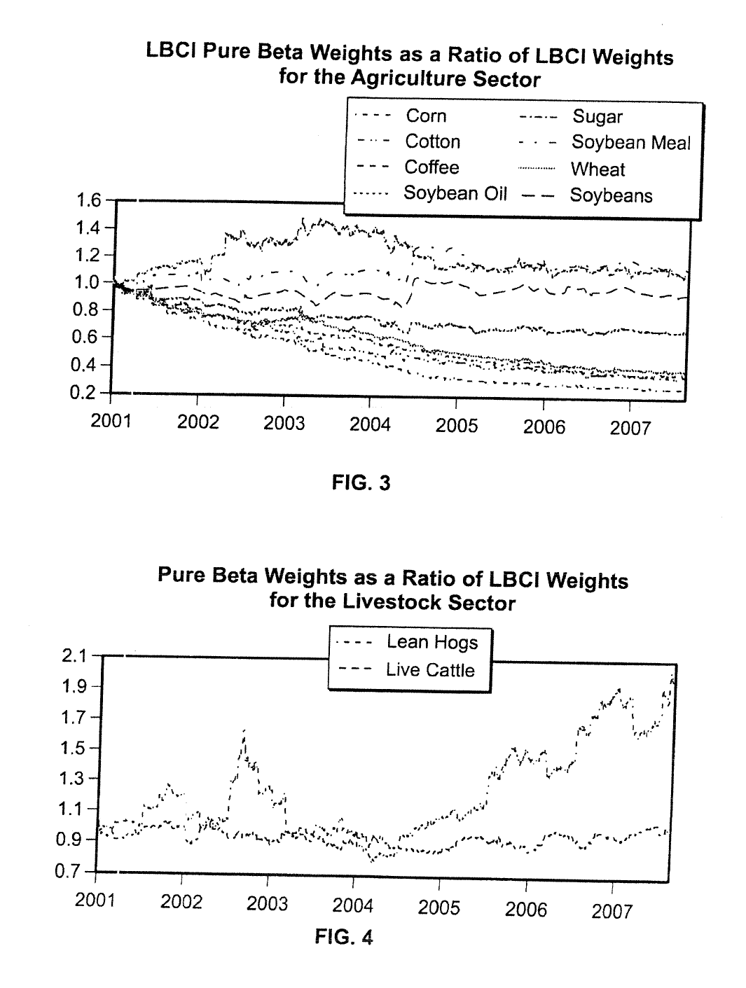

FIG. 3 depicts exemplary PBCI Weights as a ratio of LBCI Weights for the Agriculture Sector.

FIG. 4 depicts exemplary Pure Beta Weights as a ratio of LBCI Weights for the Livestock Sector.

Roll Mechanics

One difference between the LBCI and exemplary embodiments of the PBCI lies in the methodology for contract selection and the subsequent roll into the selected contracts. The LBCI uses the prompt and prompt +1 contracts according to the LBCI contract calendar (see Appendices 4 and 5), whereas one or more embodiments of the PBCI use the LBCI contract calendar, but introduces a method to select contracts based on the Forward Allocation for each commodity that has tracked the Effective Spot Price most efficiently on a quarterly basis. In these embodiments, the applicable Forward Allocation is determined by computing the correlation between all of the available Forward Allocation returns and the Effective Spot Price return, and is measured using the Tracking Mark (or correlation value) based on the exemplary Tracking Mark rules stated below.

Forward Allocation Rebalancing—Example for Crude Oil (CL)

The following is an example of the methodology implemented by software of an embodiment for switching into different Forward Allocations. In this example, Crude Oil will switch from Forward Allocation 1 (LBCI default roll) to Forward Allocation 6. This means that the daily return for the crude oil index will be derived from the excess return of the contracts within Forward Allocation 1 for the first day of the roll and then will roll into Forward Allocation 6 at 10% per day for 10 days. The Forward Allocation rebalancing process runs four times per year on the 22nd or next valid business day of January, April, July, and October. Each Forward Allocation represents a series of futures contracts from the standard LBCI contract calendar with each allocation starting with the next contract in the calendar. This is depicted in Table 2.

1/22/2007: Forward Allocation is selected based on the Tracking Mark rules.

Day0 1/23/2007: S=100%(Forward Allocation 1)

Day1 1/24/2007: S=90%(Forward Allocation 1)+10%(Forward Allocation 6)

Day2 1/25/2007: S=80%(Forward Allocation 1)+20%(Forward Allocation 6)

Day9: 2/2/2007: S=100%(Forward Allocation 6)

Where S=Crude Oil Excess Return

Forward Allocation 1=Excess Return for LBCI Crude Oil 1 month Forward

Forward Allocation 6=Excess Return for LBCI Crude Oil 6 months Forward

Forward Allocation Selection

The underlying software for selecting the roll from one Forward Allocation to another operates as follows:
Initially the Effective Spot Price is calculated using the 12 months of each commodities futures curve depending upon the contract roll schedule. This means that not all contracts that are open are used; only the contracts in the LBCI contract calendar are used.

TABLE 1
Effective Spot Price Calculations on two dates in 2001 for Crude Oil (CL)

| | Janu- | Febru- | March | April | May | June | July | Au- | Septem- | Octo- | Novem- | Decem- |
|---|---|---|---|---|---|---|---|---|---|---|---|---|
| | ary(F) | ary(G) | (H) | (J) | (K) | (M) | (N) | gust(Q) | ber(U) | ber(V) | ber(X) | ber(Z) |
| | F | G | H | J | K | M | N | Q | U | V | X | Z |
| CL Regular LBCI Roll | G/H | H/J | J/K | K/M | M/N | N/Q | Q/U | U/V | V/X | X/Z | Z/F | F/G |
| Effective Spot | H | J | K | M | N | Q | U | V | X | Z | F | G |
| Jan. 2, 2001 | | | | | | | | | | | | |
| Effective Spot | J | K | M | N | Q | U | V | X | Z | F | G | H |
| Feb. 1, 2001 | | | | | | | | | | | | |

From the example used in Table 1, the Effective Spot Price on Jan. 2, 2001 for crude oil (CL) is calculated as the sum of all the relevant contract prices multiplied by the relevant Open Interest (OI)/Sum of OI. The Open Interest for each commodity is provided by the relevant exchange, except for the metals traded on the London Metals Exchange, where Open Interest is equally distributed across all 12 months, giving a constant weight of 8.33% for each contract.
An Effective Spot Price is then calculated for each LBCI commodity for every date since index inception.
Once the Effective Spot Price series has been calculated, a time series of rolling three-monthly returns is computed using these Effective Spot Prices.
The next stage is to ascertain which of the various Forward Allocation Returns most closely correlates with the Effective Spot Price return using the Tracking Mark rules. This is achieved by computing the correlation between the rolling three-month Effective Spot Price return and the return of each Forward Allocation. The Forward Allocation return is determined each day by looking at the roll calendar for each commodity 0-12 months ahead and calculating the Excess Return using the relevant contracts.
Table 2 shows how the Forward Allocation returns of an embodiment are calculated. On Jan. 2, 2001, Forward Allocation 1 would be the equivalent to the regular LBCI roll calendar. On the same date, Forward Allocation 2 would be looking at the roll schedule as though it was one month forward and Forward Allocation 3 would be looking at a 3 month forward roll.

TABLE 2
Roll Calendar for Calculating Forward Allocations for Crude Oil (CL)

| | Forward | Janu- | Febru- | March | April | May | June | July | Au- | Septem- | Octo- | Novem- | Decem- |
|---|---|---|---|---|---|---|---|---|---|---|---|---|---|
| | Allocation | ary(F) | ary(G) | (H) | (J) | (K) | (M) | (N) | gust(Q) | ber(U) | ber(V) | ber(X) | ber(Z) |
| CL | | | | | | | | | | | | | |
| Regular | | | | | | | | | | | | | |
| LBCI Roll | | G/H | H/J | J/K | K/M | M/N | N/Q | Q/U | U/V | V/X | X/Z | Z/F | F/G |
| Jan. 2, 2001 | 1 | H | J | K | M | N | Q | U | V | X | Z | F | G |
| Jan. 2, 2001 | 2 | J | K | M | N | Q | U | V | X | Z | F | G | H |
| Jan. 2, 2001 | 3 | K | M | N | Q | U | V | X | Z | F | G | H | J |
| Jan. 2, 2001 | 4 | M | N | Q | U | V | X | Z | F | G | H | J | K |
| Jan. 2, 2001 | 5 | N | Q | U | V | X | Z | F | G | H | J | K | M |
| Jan. 2, 2001 | 6 | Q | U | V | X | Z | F | G | H | J | K | M | N |
| Jan. 2, 2001 | 7 | U | V | X | Z | F | G | H | J | K | M | N | Q |
| Jan. 2, 2001 | 8 | V | X | Z | F | G | H | J | K | M | N | Q | U |
| Jan. 2, 2001 | 9 | X | Z | F | G | H | J | K | M | N | Q | U | V |
| Jan. 2, 2001 | 10 | Z | F | G | H | J | K | M | N | Q | U | V | X |
| Jan. 2, 2001 | 11 | F | G | H | J | K | M | N | Q | U | V | X | Z |
| Jan. 2, 2001 | 12 | G | H | J | K | M | N | Q | U | V | X | Z | F |

Although the mechanics are identified for rolling between Forward Allocation 1 and Forward Allocation 6, any one of the 12-month Forward Allocations could have been selected. The Forward Allocation selection is determined by evaluating the Tracking Mark or value of the correlation between the various Forward Allocation Returns and the Effective Spot Price return as follows:

(1) Before the Tracking Mark evaluation can occur, the Forward Allocation selection process excludes those contracts in which the Open Interest in the relevant futures contract is less than 7% of the trailing 3-month average Open Interest for each of the 0-12 month contracts, as per the Allocation Restriction. This is to ensure that there is sufficient liquidity to support an investment in a particular Forward Allocation.

As a result, Tracking Mark evaluations are performed only on those contracts left after the 7% limitation has been applied. Consequently, this will exclude any Forward Allocations that use a futures contract that does not satisfy the requirement (i.e., in a commodity with 4 futures in a given 12 month period, if one futures contract is made ineligible, multiple forward allocations also will become ineligible).

(2) If all Tracking Marks are lower than the preceding one starting with Forward Allocation 1, then Forward Allocation 1 would be selected.

(3) For a Forward Allocation to be selected it must be (a) preceded by a lower Tracking Mark, and (b) followed by Tracking Marks that are sequentially lower than or equal to the previous Tracking Mark

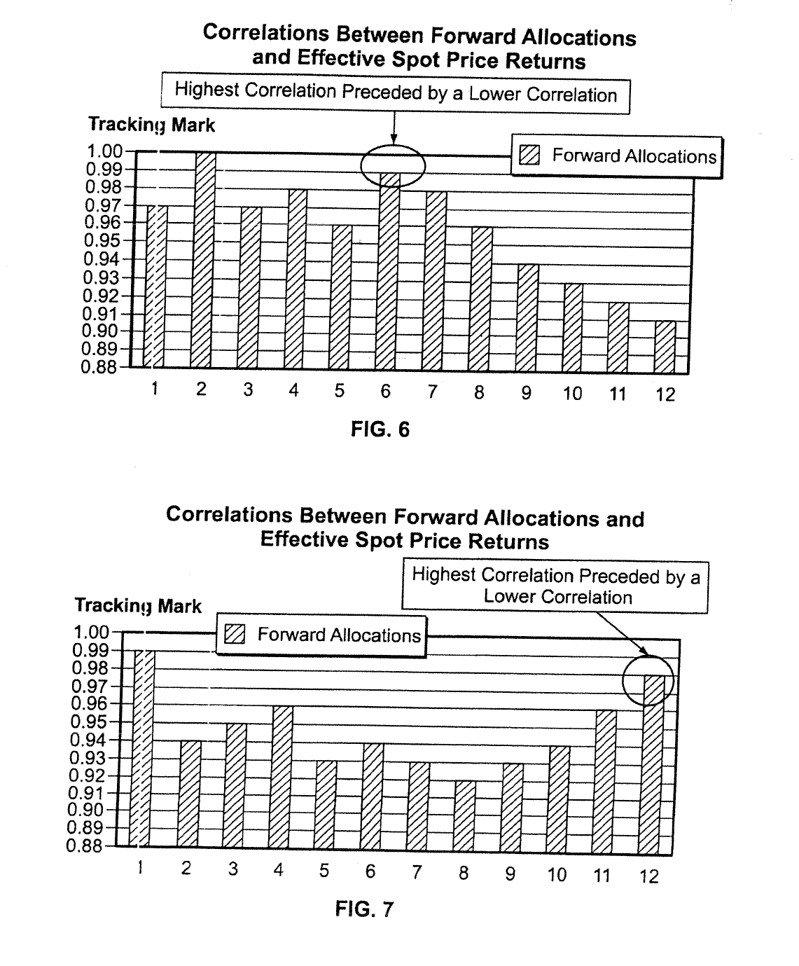

(4) If none of the preceding conditions are satisfied, then the index will allocate to Forward Allocation 12.
An exemplary illustration of a Forward Allocation selection process is depicted in FIGS. 6 and 7. These figures depict the correlation between each Forward Allocation return and the Effective Spot Price return. In FIG. 6, Forward Allocation 6 would be selected, as it is the highest correlation that is preceded by a lower one and followed by sequentially lower or equal Tracking Marks. In FIG. 7, Forward Allocation 12 would be selected because Forward Allocation 11 has a lower Tracking Mark than Forward Allocation 12 and because there is no earlier Forward Allocation that is preceded by and sequentially followed by lower or equal Tracking Marks.

Component Commodity Roll Mechanics

In addition to the Forward Allocation rebalancing process, in an exemplary embodiment the PBCI also rolls between futures contracts in the same way as the LBCI, except that the roll period for the PBCI is over 10 days (versus 5 days for the LBCI) and starts on the first day of the month. During any month in which a contract is scheduled to roll, the roll period will begin at the end of the first LBCI Business Day in that month and last for ten LBCI Business Days. During the roll period, the hypothetical position in the relevant contract is gradually shifted from the first contract in the relevant Forward Allocation to the second contract in the relevant Forward Allocation in 10% daily increments.

On the first LBCI Business Day of the relevant month, commodity excess returns will reflect 100% of the price movements of the current contract in the relevant Forward Allocation. At the end of that LBCI Business Day, 10% of the current contract in the relevant Forward Allocation will be rolled to the next contract in the relevant Forward Allocation. This process is repeated each day, taking into consideration any market disruptions until the tenth LBCI Business Day. At that point the roll will have been completed and returns will come from 100% of the price of the new contract.

Performance

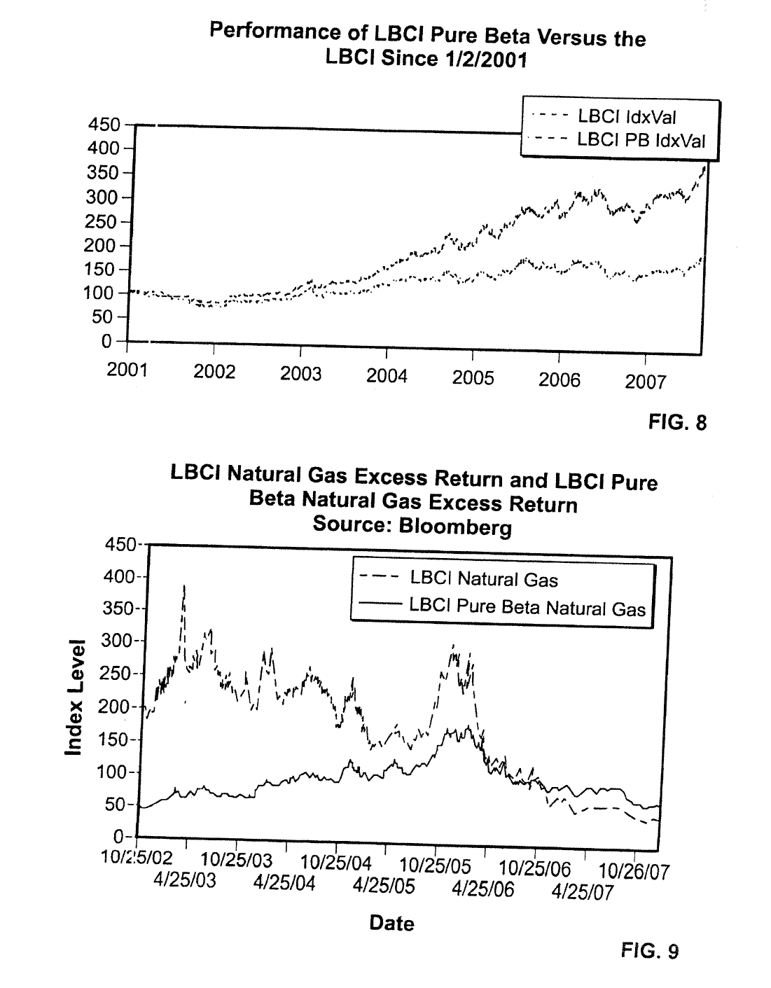

FIG. 8 depicts performance of an exemplary embodiment of the PBCI versus the LBCI. Both indices have been calibrated to 100 on Jan. 2, 2001 to facilitate comparison. This figure clearly shows how the PBCI has outperformed the standard LBCI since inception in 2001.

Timing

Initial index returns of an exemplary embodiment are published between 4 p.m. and 6 p.m. EST on each Index business day, as they are for the LBCI. Occasionally an exchange may update a final closing price after its initial publication. In those cases, returns will be updated with the new price when published.

If the price expected from an exchange is determined to be in error or is unavailable before the index is required to be published, the Index Agent reserves the right to provide a price for the contract. However, if the exchange in question provides an appropriate value before trading opens on the following day, the Index Agent will restate returns.

Market Disruption Events

A number of market circumstances can lead to an adjustment in the rolling process. These adjustments occur when it would be difficult to liquidate or establish positions in the market and perform the roll. If any of these market disruption events occurs on any of the days during the roll period, the proportion of the roll that would have taken place on that day is skipped by an exemplary embodiment. For example, if a market disruption event occurs on the first day of the roll, none of the 90/10 roll is taken. Instead, the 80/20 proportion is taken on the next business day. If a market disruption event occurs on that day also, the roll proportion will be 70/30 on the following business day.

Two examples of disruption events are:
Commodity reaches a limit price during the last 15 minutes of the trading session. If the prompt contract reaches a limit price during the final 15 minutes of regular or rescheduled trading, the roll will be skipped that day.
Trading interrupted or terminated on an exchange. If trading is terminated prior to the expected close of business and does not resume at least 15 minutes prior to the scheduled close, the roll will be deferred.

Details of further exemplary embodiments are provided below.

Index Composition and Index Contract Selection

The Index Contracts included in the PBCI in any year will be the same Index Contracts included in the general LBCI, which Index Contracts in turn are selected based on known liquidity criteria.

The 20 commodities currently represented by Index Contracts in both the LBCI generally and an exemplary embodiment of the PBCI are: crude oil, heating oil, natural gas, unleaded gas, aluminum, copper, nickel, zinc, gold, silver, lean hogs, live cattle, corn, soybean, soybean meal, soybean oil, wheat, coffee, cotton and sugar. The LBCI and PBCI each contain four major sectors: energy, metals, agriculture, and livestock. Within metals, there are additional sub-sectors for industrial metals and precious metals. Within agriculture there are sub-sectors for grains and softs.⁴ ⁴ “Softs” also are known as “food and fiber” because this group is mainly composed of food related items (cocoa, sugar, and orange juice) and cotton, which can be considered a fiber as well as a food (e.g., cotton oil).

Quarterly Re-Allocation to Forward Allocations

The PBCI, in one or more exemplary embodiments, re-allocates on a quarterly basis to potentially different Index Contract months. In particular, the PBCI re-allocates the Index Contract for each commodity in which it is invested on a quarterly basis to one of the eligible (deferred) contracts for the next twelve consecutive months under the LBCI Contract Calendar, following the exemplary “Forward Allocation” methodology described below.

In these embodiments of the PBCI, the next Forward Allocation for each commodity is selected quarterly on the 22nd of each January, April, July, and October (or if the 22nd is not an LBCI Business Day, the next LBCI Business Day) (each such day a “Re-allocation Date”), and the selection is based on the correlations between the daily Forward Allocation Returns for each of the then-active contracts in the twelve Forward Allocations for that commodity, and the daily Effective Spot Price Returns for that commodity, in each case as described below, in the immediately preceding quarterly period ending on the Re-allocation Date.

Forward Allocations

Each Forward Allocation represents a series of (deferred) forward contracts in the standard LBCI Contract Calendar of successive one-month increments up to a limit of 12 months (with Forward Allocation 1 being the series starting with the then-active forward contract in the standard LBCI Contract Calendar). In effect, for any given commodity futures contract in the LBCI in any given month, Forward Allocation 1 of the PBCI will reference the series of contracts in which the general LBCI is invested, while Forward Allocations 2 through 12 will reference those series of contracts in which the general LBCI will be invested beginning in each of the next 11 succeeding months.

For instance, below in Table 3 is the standard roll schedule for Natural Gas under the LBCI Contract Calendar (represented by the Henry Hub natural gas contracted traded on NYMEX under ticker symbol “NG”):

TABLE 3

| | Janu- | Febru- | March | April | May | June | July | Au- | Septem- | Octo- | Novem- | Decem- |
|---|---|---|---|---|---|---|---|---|---|---|---|---|
| | ary(F) | ary(G) | (H) | (J) | (K) | (M) | (N) | gust(Q) | ber(U) | ber(V) | ber(X) | ber(Z) |
| NG Regular LBCI | G/H | H/J | J/K | K/M | M/N | N/Q | Q/U | U/V | V/X | X/Z | Z/F | F/G |
| Roll | | | | | | | | | | | | |

Based on the standard LBCI Contract Calendar above, Table 4 below indicates each of Forward Allocations 1 through 12 of the NG contract, illustrating how each of the Forward Allocations is a shifting series of forward contracts in the regular LBCI Contract Calendar of successive one-month increments. Note that under the general LBCI Contract Calendar, contracts are rolled on a monthly basis (when applicable) on the sixth through tenth LBCI Business Days in each month. Thus for purposes of determining Forward Allocations in this embodiment of the PBCI, which as stated above are evaluated on the 22nd of each January, April, July and October (or if the 22nd is not an LBCI Business Day, the next LBCI Business Day), the applicable contract in the Forward Allocation will always be the second contract of any monthly pair in the LBCI Contract Calendar.

TABLE 4

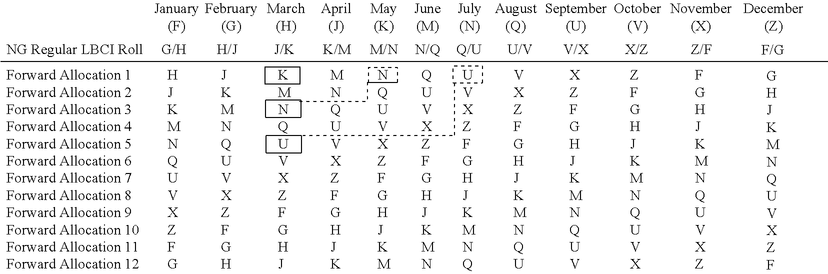

For instance, if as of March the active contract in the standard LBCI Contract Calendar is the May contract (K), in Forward Allocation 3 the active contract in March is the July contract (N) (the contract the general LBCI would be invested in for May) and in Forward Allocation 5 the active contract in March is the September contract (U) (the contract the general LBCI would be invested in for July).

Selection of the Applicable Forward Allocation

As stated above, the PBCI in this embodiment re-allocates among Forward Allocations quarterly on each Re-allocation Date, with the applicable Forward Allocation determined individually for each commodity represented in the PBCI. The Forward Allocation selected for each commodity is determined based on the correlations between (1) the daily Forward Allocation Returns for each of the Index Contracts that are the then-active contracts under each of the twelve Forward Allocations for that commodity, and (2) the daily Effective Spot Price Returns for that commodity. The calculations for the daily Forward Allocation Returns and the daily Effective Spot Price Return for any commodity are described below.

The applicable quarterly period is in each case the period from and including the first LBCI Business Day following the last Re-allocation Date to and including the current Re-allocation Date.

Effective Spot Price Return

The Effective Spot Price Return for any Index Contract is calculated on each LBCI Business Day, and for any LBCI Business Day is equal to the appreciation and/or depreciation in the Effective Spot Price from the price on the first LBCI Business Day in the trailing 3-month period ending on the applicable LBCI Business Day to the price on the applicable LBCI Business Day.

For purposes of calculating the Effective Spot Price Return for any commodity as described above, the Effective Spot Price for any LBCI Business Day is the weighted average price calculated using each Index Contract for that commodity in the 0- to 12-month measurement period (that is, the next nearby month contract plus the contract for each of the next 11 months). The weighted average spot price for each Index Contract is equal to the sum of the weighted prices of each contract month being priced. The weighted price of each monthly contract is determined by multiplying the spot price for a given month by a quotient equal to the total dollar amount invested in that month's contract, or that contract's “Open Interest,” divided by the total Open Interest in the contracts for all months being priced. The Open Interest data for each Index Contract is provided by the relevant exchange for that Index Contract. In the case of Index Contracts trading on the LME (London Metals Exchange) (i.e., Aluminum, Zinc, Nickel and Copper), the “Open Interest” is equally distributed across the 12 month measurement period because the LME does not provide daily contract OI values. This means that the OI weight for each contract will be 8.33%.

In an embodiment, prices used to calculate any Effective Spot Price or Effective Spot Price Return on or as of any LBCI Business Day will be the closing prices for the applicable months of each Index Contract on that Index Contract's relevant exchange on that day.

Forward Allocation Return

Like the Effective Spot Price Return, the Forward Allocation Return for each of Forward Allocations 1 through 12 is calculated on each LBCI Business Day, and for any LBCI Business Day is equal to the appreciation and/or depreciation in the spot price for the then-active contract in the applicable Forward Allocation from the price on the first LBCI Business Day in the trailing 3-month period ending on the applicable LBCI Business Day to the price for the active contract on the applicable LBCI Business Day.

The Forward Allocation Return is an “excess” return because the change in the two relevant prices will include both changes in spot price for the contract under the given Forward Allocation and the roll yield for any roll between contract months under that Forward Allocation during the trailing 3-month period (calculated as if that contract was being rolled in accordance with the LBCI Contract Calendar).

Prices used to calculate any Forward Allocation Return on or as of any LBCI Business Day will be the closing prices for the applicable contract on that contract's relevant exchange on that day.

Tracking Mark

As with the exemplary embodiments described above, on each Re-allocation Date in this embodiment, a correlation value, or “Tracking Mark,” for each Forward Allocation for a commodity is calculated between the daily Forward Allocation Returns for that Forward Allocation and the daily Effective Spot Price Returns for that commodity, in each case, for the applicable 3-month trailing period. Index Contracts in which the trailing 3-month average Open Interest in the relevant futures contract as of the Re-allocation Date is less than 7.0% of the trailing 3-month average total Open Interest for each of the 0- to 12-month Index Contracts are excluded from Tracking Mark calculations and from consideration under the quarterly re-allocation. This limitation is designed to ensure there is sufficient liquidity to support an investment in the futures contracts within the selected Forward Allocation.

The Forward Allocation into which the PBCI will be invested for the next quarterly period will be the Forward Allocation with the highest Tracking Mark that also satisfies the following rules:
For a Forward Allocation to be selected, (1) the immediately preceding Forward Allocation must have a lower Tracking Mark; and (2) the succeeding Forward Allocations must have Tracking Marks that are sequentially lower than or equal to the previous Tracking Mark.
If Forward Allocation 1 has the highest Tracking Mark and all succeeding Forward Allocations have Tracking Marks that are sequentially lower than or equal to the previous Tracking Mark, Forward Allocation 1 would be selected.
If none of the preceding conditions are satisfied (i.e. if Forward Allocation 11 has a lower Tracking Mark than Forward Allocation 12) then the PBCI will allocate to Forward Allocation 12.

Table 5 indicates the Forward Allocations for each Index Contract in which the PBCI was invested for each quarterly re-allocation from and including the quarterly period beginning on the first LBCI Business Day after the Oct. 25, 2000 Re-allocation Date to and including the current quarterly re-allocation period that begins on the first LBCI Business Day after the Oct. 22, 2007 Re-allocation Date.

TABLE 5

| | Energy | | | | | | | | Precious | |
|---|---|---|---|---|---|---|---|---|---|---|
| | WTI | Natural | | Heating | Industrial Metals | | | | Metals | |
| Period | Crude Oil | Gas | Gasoline | Oil | Aluminum | Copper | Nickel | Zinc | Gold | Silver |
| Beginning | CL | NG | RB | HO | LA | LP | LN | LX | GC | SI |
| Jan. 2, 2001 | 2 | 4 | 3 | 2 | 11 | 6 | 6 | 6 | 4 | 1 |
| Jan. 24, 2001 | 3 | 4 | 2 | 4 | 11 | 8 | 9 | 9 | 1 | 1 |
| Apr. 25, 2001 | 3 | 1 | 4 | 4 | 9 | 6 | 5 | 6 | 3 | 3 |
| Jul. 25, 2001 | 2 | 6 | 3 | 7 | 9 | 10 | 7 | 8 | 3 | 4 |
| Oct. 24, 2001 | 4 | 7 | 1 | 6 | 7 | 7 | 10 | 7 | 3 | 2 |
| Jan. 24, 2002 | 3 | 4 | 5 | 4 | 6 | 7 | 7 | 7 | 1 | 1 |
| Apr. 24 2002 | 3 | 8 | 4 | 4 | 8 | 6 | 4 | 9 | 2 | 3 |
| Jul. 24, 2002 | 2 | 7 | 4 | 6 | 8 | 5 | 7 | 7 | 3 | 3 |
| Oct. 24, 2002 | 1 | 5 | 2 | 5 | 7 | 5 | 7 | 7 | 3 | 2 |
| Jan. 24, 2003 | 4 | 3 | 1 | 4 | 8 | 9 | 7 | 8 | 1 | 3 |
| Apr. 24, 2003 | 2 | 8 | 4 | 3 | 6 | 10 | 6 | 6 | 2 | 3 |
| Jul. 24, 2003 | 2 | 6 | 2 | 5 | 6 | 7 | 6 | 6 | 6 | 5 |
| Oct. 24, 2003 | 2 | 3 | 3 | 3 | 6 | 11 | 6 | 5 | 2 | 4 |
| Jan. 26, 2004 | 2 | 2 | 2 | 3 | 5 | 9 | 7 | 8 | 2 | 2 |
| Apr. 26, 2004 | 2 | 2 | 1 | 1 | 7 | 9 | 7 | 7 | 2 | 8 |
| Jul. 26, 2004 | 4 | 5 | 3 | 1 | 5 | 6 | 5 | 8 | 1 | 6 |
| Oct. 26, 2004 | 2 | 4 | 4 | 2 | 5 | 6 | 6 | 6 | 3 | 4 |
| Jan. 26, 2005 | 1 | 3 | 5 | 2 | 6 | 6 | 8 | 8 | 2 | 2 |
| Apr. 26, 2005 | 3 | 8 | 2 | 1 | 7 | 7 | 7 | 6 | 2 | 2 |
| Jul. 26, 2005 | 2 | 7 | 3 | 1 | 5 | 7 | 6 | 6 | 4 | 6 |
| Oct. 26, 2005 | 3 | 6 | 4 | 5 | 6 | 6 | 8 | 7 | 2 | 3 |
| Jan. 25, 2006 | 3 | 1 | 4 | 3 | 6 | 6 | 7 | 7 | 2 | 3 |
| Apr. 26, 2006 | 3 | 9 | 2 | 2 | 6 | 11 | 7 | 7 | 2 | 3 |
| Jul. 26, 2006 | 2 | 8 | 4 | 2 | 7 | 7 | 9 | 6 | 4 | 5 |
| Oct. 25, 2006 | 3 | 6 | 1 | 2 | 6 | 7 | 8 | 6 | 4 | 4 |
| Jan. 24, 2007 | 3 | 3 | 1 | 2 | 5 | 8 | 7 | 6 | 1 | 1 |
| Apr. 25, 2007 | 3 | 1 | 3 | 3 | 7 | 6 | 6 | 5 | 8 | 8 |
| Jul. 25, 2007 | 3 | 8 | 2 | 3 | 8 | 7 | 7 | 7 | 4 | 5 |
| Oct. 24, 2007 | 4 | 7 | 2 | 2 | 4 | 7 | 1 | 8 | 2 | 4 |

| | Agriculture | | | | | | | | Livestock | |
|---|---|---|---|---|---|---|---|---|---|---|
| | | | Soy- | | Soy- | | | | Live | |
| | Soy- | | bean | | bean | Cof- | Cot- | Sug- | Cat- | Lean |
| Period | beans | Corn | Meal | Wheat | Oil | fee | ton | ar | tle | Hogs |
| Beginning | S | C | SM | W | BO | KC | CT | SB | LC | LH |
| Jan. 2, 2001 | 3 | 4 | 3 | 4 | 3 | 4 | 4 | 6 | 10 | 4 |
| Jan. 24, 2001 | 6 | 3 | 5 | 4 | 5 | 3 | 4 | 4 | 10 | 3 |
| Apr. 25, 2001 | 7 | 3 | 5 | 2 | 1 | 4 | 6 | 6 | 4 | 3 |
| Jul. 25, 2001 | 3 | 6 | 5 | 5 | 5 | 4 | 2 | 4 | 5 | 3 |
| Oct. 24, 2001 | 2 | 2 | 4 | 4 | 4 | 4 | 2 | 3 | 5 | 1 |
| Jan. 24, 2002 | 6 | 3 | 5 | 1 | 4 | 4 | 3 | 4 | 6 | 3 |
| Apr. 24 2002 | 2 | 4 | 6 | 3 | 5 | 3 | 7 | 6 | 6 | 2 |
| Jul. 24, 2002 | 2 | 6 | 2 | 2 | 4 | 4 | 5 | 5 | 5 | 4 |
| Oct. 24, 2002 | 3 | 2 | 2 | 3 | 1 | 4 | 3 | 5 | 5 | 3 |
| Jan. 24, 2003 | 5 | 3 | 7 | 3 | 4 | 2 | 4 | 2 | 4 | 2 |
| Apr. 24, 2003 | 4 | 3 | 4 | 3 | 6 | 1 | 3 | 1 | 1 | 2 |
| Jul. 24, 2003 | 3 | 3 | 1 | 2 | 1 | 3 | 5 | 5 | 5 | 5 |
| Oct. 24, 2003 | 3 | 3 | 3 | 2 | 3 | 4 | 4 | 4 | 3 | 3 |
| Jan. 26, 2004 | 3 | 3 | 4 | 2 | 4 | 2 | 4 | 4 | 4 | 4 |
| Apr. 26, 2004 | 4 | 2 | 4 | 2 | 3 | 2 | 2 | 4 | 3 | 2 |
| Jul. 26, 2004 | 5 | 3 | 5 | 4 | 5 | 4 | 4 | 4 | 4 | 3 |
| Oct. 26, 2004 | 3 | 2 | 3 | 2 | 4 | 3 | 1 | 3 | 3 | 3 |
| Jan. 26, 2005 | 4 | 4 | 5 | 2 | 5 | 2 | 4 | 2 | 4 | 3 |
| Apr. 26, 2005 | 6 | 6 | 3 | 2 | 2 | 2 | 2 | 4 | 1 | 3 |
| Jul. 26, 2005 | 2 | 6 | 2 | 5 | 2 | 4 | 2 | 2 | 5 | 4 |
| Oct. 26, 2005 | 2 | 2 | 3 | 4 | 2 | 4 | 4 | 6 | 2 | 4 |
| Jan. 25, 2006 | 2 | 3 | 6 | 2 | 2 | 1 | 4 | 2 | 2 | 4 |
| Apr. 26, 2006 | 4 | 8 | 4 | 8 | 4 | 1 | 2 | 2 | 1 | 2 |
| Jul. 26, 2006 | 2 | 2 | 1 | 2 | 3 | 4 | 6 | 2 | 4 | 4 |
| Oct. 25, 2006 | 2 | 4 | 1 | 3 | 2 | 4 | 3 | 6 | 1 | 3 |
| Jan. 24, 2007 | 1 | 1 | 2 | 3 | 2 | 4 | 2 | 4 | 3 | 4 |
| Apr. 25, 2007 | 4 | 7 | 4 | 4 | 5 | 2 | 8 | 4 | 1 | 4 |
| Jul. 25, 2007 | 2 | 4 | 4 | 6 | 4 | 4 | 5 | 3 | 4 | 5 |
| Oct. 24, 2007 | 2 | 4 | 3 | 2 | 3 | 3 | 4 | 1 | 3 | 4 |

Source: Lehman Brothers. Data from Jan. 2, 2001 through Oct. 26, 2007.

Re-Allocation Roll Mechanics

Once a Forward Allocation has been selected for each Index Contract on a Re-allocation Date using the methodology above, the PBCI, in an embodiment, then rolls between the previous Forward Allocations and the new Forward Allocations. The Forward Allocation roll is conducted similarly to the monthly contract roll under the LBCI, subject to the differences described below.

The roll period for the Forward Allocations will begin on the first LBCI Business Day after the Re-Allocation Date (that is, the 23rd of each January, April, July and October, unless such day is not an LBCI Business Day) and last for ten LBCI Business Days.

During the roll period, the hypothetical position in the Index Contract is gradually shifted from the active (or “prompt”) contract in the current Forward Allocation to the prompt contract in the new Forward Allocation in 10% daily increments. During the reallocation roll, the return for each Index Contract will be a composite of the prompt Index Contract under the previous Forward Allocation and the active Index Contract under the new Forward Allocation, weighted by the percentage that has been rolled at the end of the applicable LBCI Business Day. Accordingly, during the re-allocation roll period for a given Index Contract, the returns for that Index Contract are calculated as shown in Table 6:

TABLE 6

| | | Current Forward | New Forward |
|---|---|---|---|
| LBCI Business Day | | Allocation | Allocation |
| 1^{st} | Index Business Day after 22^{nd} | 100% | 0% |
| 2^{nd} | Index Business day after 22^{nd} | 90% | 10% |
| 3^{rd} | Index Business day after 22^{nd} | 80% | 20% |
| 4^{th} | Index Business day after 22^{nd} | 70% | 30% |
| 5^{th} | Index Business day after 22^{nd} | 60% | 40% |
| 6^{th} | Index Business day after 22^{nd} | 50% | 50% |
| 7^{th} | Index Business day after 22^{nd} | 40% | 60% |
| 8^{th} | Index Business day after 22^{nd} | 30% | 70% |
| 9^{th} | Index Business day after 22^{nd} | 20% | 80% |
| 10^{th} | Index Business day after 22^{nd} | 10% | 90% |
| 11^{th} | Index Business day after 22^{nd} | 0% | 100% |

At the end of the tenth following LBCI Business Day, the prompt contract under the previous Forward Allocation will have been fully rolled into the new Forward Allocation, which Forward Allocation will then be utilized to calculate the excess returns on the PBCI until the next Re-allocation Date.

Similar to the monthly contract roll, a number of market circumstances can lead to an adjustment in the re-allocation roll process. If any of these market disruption events occurs on any of the days during the roll period, then the proportion of the roll that would have taken place on that day is skipped.

PBCI Commodity Roll Mechanics

During any month in which an Index Contract is scheduled to roll, the roll period will begin at the end of the first LBCI Business Day in that month and last for ten LBCI Business Days. During the roll period, the hypothetical position in the Index Contract is gradually shifted from the first Index Contract in the relevant Forward Allocation to the second Index Contract in the relevant Forward Allocation (i.e., the Index Contract with the next nearest expiration) in 10% daily increments. The daily price of the Index Contract during the roll period, as well as the previous day's price of the Index Contract against which the appreciation or depreciation of the daily Index Contract price is measured, therefore will each be a composite price of the then-current Index Contract within the relevant Forward Allocation and the next Index Contract within the relevant Forward Allocation weighted by the percentage that has been rolled at the end of the previous LBCI Business Day. Accordingly, during the roll period for a given Index Contract, the returns for that Index Contract are calculated as follows:
On the first LBCI Business Day of the relevant month, Index Contract excess returns will reflect 100% of the price movements of the current Index Contract in the relevant Forward Allocation. At the end of that LBCI Business Day, 10% of the current Index Contract in the relevant Forward Allocation will be rolled to the next Index Contract in the relevant Forward Allocation.
At the beginning of the second LBCI Business Day in that month, the excess returns on the Index Contract will reflect a contract “basket” containing 90% of the current Index Contract in the relevant Forward Allocation and 10% of the next Index Contract in the relevant Forward Allocation at the start of that day. Excess returns will be calculated on this “basket.” At the end of that second LBCI Business Day, an additional 10% is rolled.
For the third LBCI Business Day, the “basket” will consist of 80% of the current Index Contract in the relevant Forward Allocation/20% next Index Contract in the relevant Forward Allocation.
For the fourth LBCI Business Day, the “basket” will consist of 70% of the current Index Contract in the relevant Forward Allocation/30% next Index Contract in the relevant Forward Allocation.
For the fifth LBCI Business Day, the “basket” will consist of 60% of the current Index Contract in the relevant Forward Allocation/40% next Index Contract in the relevant Forward Allocation.
For the sixth LBCI Business Day, the “basket” will consist of 50% of the current Index Contract in the relevant Forward Allocation/50% next Index Contract in the relevant Forward Allocation.
For the seventh LBCI Business Day, the “basket” will consist of 40% of the current Index Contract in the relevant Forward Allocation/60% next Index Contract in the relevant Forward Allocation.
For the eighth LBCI Business Day, the “basket” will consist of 30% of the current Index Contract in the relevant Forward Allocation/70% next Index Contract in the relevant Forward Allocation.
For the ninth LBCI Business Day, the “basket” will consist of 20% of the current Index Contract in the relevant Forward Allocation/80% next Index Contract in the relevant Forward Allocation.
At the end of the tenth LBCI Business Day of the relevant month, 100% of the current Index Contract in the relevant Forward Allocation will have been fully rolled into the next Index Contract in the relevant Forward Allocation, which then becomes the new current contract until the next roll period.

Returns on an Index Contract on and after the tenth LBCI Business Day in a month in which it is rolled will comprise 100% of the new Index Contract in the relevant Forward Allocation contract that has just been fully rolled into (which was formerly the next Index Contract in the relevant Forward Allocation at the start of that month).

PBCI Return Calculations

Once an embodiment of the PBCI is invested in a given Forward Allocation for each Index Contract, monthly rolls for that Index Contract will follow the general LBCI Contract Calendar until the next Re-allocation Date, except that the contract months from and into which the Index Contract rolls will be those corresponding to the new Forward Allocation selected on the applicable Re-allocation Date and will follow the PBCI roll methodology described in “PBCI Commodity Roll Mechanics” above.

The returns for the PBCI are calculated in the same manner as for the general LBCI, except that (a) the spot return for a commodity Forward Allocation on any day other than during a roll period will equal the spot return on the then-active contract under the Forward Allocation, and (b) during a roll period, the roll yield on the commodity Forward Allocation will be the roll yield from rolling between the applicable contracts under the Forward Allocation.

PBCI Initial Annual and Daily Weightings

The PBCI, in an embodiment, will inherit the liquidity factors determined for the general LBCI each January, and these liquidity factors will be rolled into the PBCI during the January LBCI monthly roll in the same manner as for the LBCI. See “The Lehman Brothers Commodity Index Calculating Commodity Liquidity Factors and LBCI Weights” below. However, the PBCI does not re-balance to the initial target weights determined for the applicable Index Contracts in the general LBCI (other than the initial target weights at inception of the PBCI and general LBCI on Jan. 1, 2001), nor does the PBCI re-weight or re-balance on any quarterly Re-allocation Date.

As with the general LBCI, the liquidity factors will remain constant for the PBCI, but similar to the general LBCI, the daily PBCI weightings will adjust throughout the year. However, the daily weightings for the PBCI will not be determined in relation to the prices of the underlying Index Contracts, but rather in relation to the levels of the applicable component excess return sub-indices for each Index Contract (with the level of each sub-index including the excess return associated with an investment in that Index Contract.

As a result of the foregoing, the weightings of the component commodities in the PBCI will differ from those in the general LBCI, perhaps substantially. Table 7 below shows the daily weightings for both the PBCI and general LBCI at Sep. 30, 2007. These daily weightings are not necessarily indicative of the future daily weightings of any particular Index Contract, commodity or sector in either the PBCI or the LBCI.

TABLE 7

| | | | Daily LBCI | Daily PBCI |
|---|---|---|---|---|
| Sector & Commodity Selection | | | Weights at | Weights at |
| Sector/ | | | Sep. 30, | Sep. 30, |
| Commodity | Contract | Exch. | 2007 | 2007 |
| Energy | | | 58.99% | 64.47% |
| Crude Oil | West Texas | NYM | 32.88% | 36.28% |
| | Intermediate | | | |
| Natural | Henry Hub | NYM | 11.41% | 9.25% |
| Gas | Natural Gas | | | |
| Unleaded | NY Harbor/ | NYM | 6.46% | 10.29% |
| Gas | RBOB (1) | | | |
| Heating | No. 2 Heating | NYM | 8.24% | 8.65% |
| Oil | Oil NY | | | |
| Metals | | | 22.46% | 21.12% |
| Industrial | | | 14.69% | 16.03% |
| Metals | | | | |
| Aluminum | High Grade | LME | 3.61% | 3.45% |
| | Primary | | | |
| | Aluminum | | | |
| Copper | Copper-Grade A | LME | 8.80% | 9.90% |
| Nickel | Primary Nickel | LME | 1.07% | 1.67% |
| Zinc | Special High | LME | 1.21% | 1.01% |
| | Grade Zinc | | | |
| Precious Metals | | | 7.77% | 5.09% |
| Gold | Gold | CMX | 6.12% | 4.00% |
| Silver | Silver | CMX | 1.65% | 1.09% |
| Agricultural | | | 16.20% | 14.41% |
| Grains | | | 13.35% | 9.74% |
| Soybeans | Soybeans | CBT | 5.87% | 5.65% |
| Corn | Corn | CBT | 2.37% | 0.87% |
| Soybean | Soybean Meal | CBT | 1.54% | 1.55% |
| Meal | | | | |
| Wheat | Chicago | CBT | 2.54% | 0.96% |
| Soybean | Soybean Oil | CBT | 1.03% | 0.71% |
| Oil | | | | |
| Softs | | | 2.85% | 1.46% |
| Coffee | Coffee “C” | NYBOT | 1.08% | 0.27% |
| Cotton | Cotton #2 | NYBOT | 0.82% | 0.29% |
| Sugar | World Sugar | NYBOT | 0.95% | 0.90% |
| | #11 | | | |
| Livestock | | | 2.35% | 3.21% |
| Live Cattle | Live Cattle | CME | 1.52% | 1.42% |
| Lean Hogs | Lean Hogs | CME | 0.84% | 1.79% |
| | | Total | 100.00% | 100.00% |

Pure Beta Brent

One embodiment (“PBCI Brent”) is the PBCI variant of the LBCI Brent, and is equivalent in all respects as to its characteristics and methodologies to the other Component Sub-Indices. The LBCI Brent is a single-commodity index that represents an interest in the Brent Crude oil contract (the “Brent Crude Contract”), and follows the same methodologies as the LBCI, including as to the Index Contract calendar and roll schedule, monthly roll periods, performance calculation, and disruption events. The Brent Crude Contract trades on the Inter Continental Exchange under the symbol “SC”. The LBCI Brent was launched on Jul. 12, 2007, and its initial level was set to 100 as of Jun. 30, 2006, to correspond to the initial levels of the general LBCI and each sub-index of the LBCI, each of which were set to 100 as of that date. The PBCI Brent was launched on Oct. 10, 2007, in conjunction with the launch of the PBCI, and its level was set to 100 as of Jun. 30, 2006, to correspond to the level of the LBCI Brent set to 100 as of that date.

The LBCI Brent and the PBCI Brent each reflect the excess returns that are potentially available through an unleveraged investment in the Brent Crude Contract.

The “excess returns” of each of the LBCI Brent and the PBCI Brent are the combined return of spot price movements and roll yield associated with the Brent Crude Contract. The final level of the LBCI Brent is published daily on Bloomberg Page LBCOER, and the final level of the PBCI Brent is published daily on Bloomberg Page LPCOER.

The LBCI Contract Calendar specifies which Index Contracts (by settlement month) are used to calculate the LBCI returns for each monthly reporting period. The contract calendar and roll schedule for Brent Crude is the same as the contract calendar and roll schedule for the Crude Oil West Texas Intermediate contract under the general LBCI Contract Calendar, except that the Brent Crude Contract is always one month ahead of the contract for Crude Oil West Texas Intermediate. So, for example, if the current contract for Crude Oil West Texas Intermediate is the January/February contract, the current contract for Brent Crude would be February/March. For further information on the LBCI Contract Calendar, see Appendices 4 and 5.

Buffered Return Enhanced Notes Linked to a Basket of PBCI Excess Return Sub-Indices

In an embodiment, the invention further comprises Buffered Return Enhanced Notes linked to a basket of PBCI excess return sub-indices. An exemplary term sheet for these notes is provided in Appendix 3. Selected terms are discussed below.

The Issue Price is 100%, and the notes do not bear interest. The notes are linked to a Basket consisting of Component Sub-Indices. Each Component Sub-index is calculated and published by an Index Sponsor, subject to adjustment in accordance with Index Adjustment.

The Component Sub-Indices and the Component Weighting for each Component Sub-Index are as set forth in Table 8:

TABLE 8

| | Component |
|---|---|
| Component Sub-Index | Weighting |
| LBCI Pure Beta Natural Gas Excess Return | 10.00% |
| (“LBCIPB Natural Gas”) | |
| LBCI Pure Beta Crude Oil Excess Return | 5.00% |
| (“LBCIPB WTI Crude”) | |
| LBCI Pure Beta Brent Excess Return | 5.00% |
| (“LBCIPB Brent Crude”) | |
| LBCI Pure Beta Unleaded Gas Excess Return | 3.00% |
| (“LBCIPB Gasoline”) | |
| LBCI Pure Beta Heating Oil Excess Return | 2.00% |
| (“LBCIPB Heating Oil”) | |
| LBCI Pure Beta Live Cattle Excess Return | 4.00% |
| (“LBCIPB Live Cattle”) | |
| LBCI Pure Beta Lean Hogs Excess Return | 2.00% |
| (“LBCIPB Lean Hogs”) | |
| LBCI Pure Beta Wheat Excess Return | 4.00% |
| (“LBCIPB Wheat”) | |
| LBCI Pure Beta Corn Excess Return | 6.00% |
| (“LBCIPB Corn”) | |
| LBCI Pure Beta Soybeans Excess Return | 7.00% |
| (“LBCIPB Soybeans”) | |
| LBCI Pure Beta Soybean Oil Excess Return | 3.00% |
| (“LBCIPB Soybean Oil”) | |
| LBCI Pure Beta Aluminum Excess Return | 7.50% |
| (“LBCIPB Aluminum”) | |
| LBCI Pure Beta Copper Excess Return | 7.50% |
| (“LBCIPB Copper”) | |
| LBCI Pure Beta Zinc Excess Return | 4.00% |
| (“LBCIPB Zinc”) | |
| LBCI Pure Beta Nickel Excess Return | 6.00% |
| (“LBCIPB Nickel”) | |
| LBCI Pure Beta Gold Excess Return | 9.50% |
| (“LBCIPB Gold”) | |
| LBCI Pure Beta Silver Excess Return | 2.50% |
| (“LBCIPB Silver”) | |
| LBCI Pure Beta Sugar Excess Return | 4.00% |
| (“LBCIPB Sugar”) | |
| LBCI Pure Beta Cotton Excess Return | 4.00% |
| (“LBCIPB Cotton”) | |
| LBCI Pure Beta Coffee Excess Return | 4.00% |
| (“LBCIPB Coffee”) | |

Redemption Amount: A single U.S. dollar payment on the Maturity Date equal to the principal amount of the notes multiplied by:

100% +(Basket Return x Upside Participation Rate) if the Final Basket Level is greater than the Initial Basket Level;

100% if the Final Basket Level is equal to or less than the Initial Basket Level but greater than or equal to the Buffer Level; or 100% +(Basket Return+Protection Percentage) if the Final Basket Level is less than the Buffer Level.

The notes are only 20% principal protected, even if held to maturity, and an investor may lose a substantial part of his investment. If the Basket Return is less than the Buffer Level (that is, if the Final Basket Level has declined by more than 20.0% relative to the Initial Basket Level), an investor will lose principal in proportion to the percentage by which the decline in the Final Basket Level relative to the Initial Basket Level exceeds 20.0%. Accordingly, in such circumstances the Redemption Amount will be less than, and may be as little as, 20% of the principal amount invested.

Upside Participation Rate is 181.0%; Protection Percentage is 20.0%; and Buffer Level is 80.0% of the Initial Basket Level.

Basket Return is Final Basket Level—Initial Basket Level

Initial Basket Level is expressed as a percentage (rounded to three decimal places), and is et to 100 on the Trade Date.

Final Basket Level is 100×(1+the sum of the Weighted Component Sub-Index Returns).

Weighted Component Sub Index Returns are calculated as follows: for each Component Sub-Index, Component Weighting×Final Index Value−Initial Index Value.

Initial Index Value is calculated as follows: for each Component Sub-Index, the

Index Value of the Component Sub-Index on the Trade Date, as set forth in Table 9:

TABLE 9

| Component Sub-Index | Initial Index Value |
|---|---|
| LBCIPB Natural Gas | 69.4364 |
| LBCIPB WTI Crude | 104.0448 |
| LBCIPB Brent Crude | 102.7882 |
| LBCIPB Gasoline | 124.8300 |
| LBCIPB Heating Oil | 94.7922 |
| LBCIPB Live Cattle | 105.4617 |
| LBCIPB Lean Hogs | 105.8668 |
| LBCIPB Wheat | 194.8825 |
| LBCIPB Corn | 134.3649 |
| LBCIPB Soybeans | 142.7296 |
| LBCIPB Soybean Oil | 140.0817 |
| LBCIPB Aluminum | 103.0509 |
| LBCIPB Copper | 122.5884 |
| LBCIPB Zinc | 108.4202 |
| LBCIPB Nickel | 197.7906 |
| LBCIPB Gold | 118.2720 |
| LBCIPB Silver | 123.2873 |
| LBCIPB Sugar | 54.4007 |
| LBCIPB Cotton | 102.9430 |
| LBCIPB Coffee | 101.0169 |

Final Index Value is calculated as follows: for each Component Sub-Index, the Index Value of the Component Sub-Index on the Valuation Date.

Index Value is calculated as follows: for each Component Sub-Index, the closing level of that Component Sub-Index, as determined and published by the Index Sponsor (subject to the occurrence of a Market Disruption Event or an Index

Unavailability Event), rounded to four decimal places.

Market Disruption Events: If a Market Disruption Event relating to one or more Component Sub-Indices is in effect on the scheduled Valuation Date, the Calculation Agent will calculate the Final Basket Level using:
for each such Component Sub-Index that did not suffer a Market Disruption Event on the scheduled Valuation Date, the Final Index Level for that Component Sub-Index on the scheduled Valuation Date, and
for each such Component Sub-Index that did suffer a Market Disruption Event on the scheduled Valuation Date, the Final Index Level on the immediately succeeding trading day for such Component Sub-Index on which no Market Disruption Event occurs or is continuing with respect to such Component Sub-Index;

provided, however, that if a Market Disruption Event has occurred or is continuing with respect to a Component Sub-Index on each of the eight scheduled trading days following the scheduled Valuation Date, then (a) that eighth scheduled trading day shall be deemed the Valuation Date for the affected Component Sub-Index; and (b) the Calculation Agent will determine the Final Index Value for the affected Component Sub-Index on such day in good faith in accordance with the formula for and method of calculating the Component Sub-Index last in effect prior to commencement of the Market Disruption Event using a price for the Index Contract on such eighth scheduled Index Business Day determined by the Calculation Agent in its sole and absolute discretion taking into account the latest available quotation for the price of the Index Contract applicable to such Component Sub-Index and any other information that in good faith it deems relevant.

A “Market Disruption Event” for a Component Sub-Index means any of the following events, in each case as determined in good faith by the Calculation Agent:

(A) the termination or suspension of, or material limitation or disruption in the trading on the applicable Relevant Exchange of the Index Contract for that Component Sub-Index;

(B) the settlement price on the applicable Relevant Exchange of the Index Contract for that Component Sub-Index has increased or decreased by an amount equal to the maximum permitted price change from the previous day's settlement price; or

(C) the settlement price of the Index Contract for that Component Sub-Index is not published by the applicable Relevant Exchange.

Notwithstanding the foregoing, the following events will not constitute a Market Disruption Event for a Component Sub-Index:

(1) a limitation on the hours in a trading day and/or number of days of trading, if it results from an announced change in the regular business hours of the applicable Relevant Exchange of the Index Contract for that Component Sub-Index; or

(2) a decision to permanently discontinue trading in the Index Contract for that Component Sub-Index or options or futures contracts relating to that Index Contract of the related Component Sub-Index.

For purposes of the above, (a) “Index Contract” means the commodity contract then underlying each Component Sub-Index or any Successor Sub-Index; (b) “Relevant Exchange” means any organized exchange or market of trading for the Index Contract then included in the Component Sub-Index or any Successor Sub-Index; and (c) “trading day” means a day, as determined in good faith by the Calculation Agent, on which trading is generally conducted on the Relevant Exchange applicable to the Index Contract for the affected Component Sub-Index.

Index Unavailability Event: If an Index Unavailability Event for any Component Sub-Index is in effect on the scheduled Valuation Date (and no Market Disruption Event is then in effect for that Component Sub-Index), the Calculation Agent will determine the Final Index Value for the affected Component Sub-Index on the Valuation Date in good faith in accordance with the formula for and method of calculating the Component Sub-Index last in effect prior to commencement of the Index Unavailability Event, using the closing price on the Valuation Date for the Index Contract for the Component Sub-Index on the Relevant Exchange for that Index Contract.

An “Index Unavailability Event” for a Component Sub-Index means that the Component Sub-Index is not calculated and published by the Index Sponsor or any Successor Sub-Index is not calculated and published by the sponsors thereof.

Index Adjustment: If the Index Sponsor discontinues publication of a Component Sub-Index and the Index Sponsor or another entity publishes a successor or substitute index that the Calculation Agent determines, in its sole discretion, to be comparable to the discontinued Component Sub-Index (such a comparable index is a “Successor Sub-Index”), then the Final Index Value for such Component Sub-Index will be determined by reference to the level of such Successor Sub-Index at the close of trading on the Relevant Exchange or market of the Index Contract for that Successor Sub-Index on the Valuation Date; provided, however, that the Calculation Agent may make such adjustments as it deems necessary to the level of the Successor Sub-Index so that the level of the Successor Sub-Index reflects the same level as that of the discontinued Component Sub-Index before it was discontinued. Upon any selection by the Calculation Agent of a Successor Sub-Index for any Component Sub-Index, the Calculation agent will cause written notice thereof to be promptly furnished to the trustee, to the Issuer and to the holders of the notes.

If the Index Sponsor discontinues publication of a Component Sub-Index prior to, and such discontinuation is continuing on, the Valuation Date, and the Calculation Agent determines that no Successor Sub-Index is available at such time, then the Calculation Agent will determine the Final Index Value for such Component Sub-Index on the Valuation Date. The Final Index Value for such Component Sub-Index will be computed by the Calculation Agent in accordance with the formula for and method of calculating such Component Sub-Index last in effect prior to such discontinuation, using the settlement price of the Index Contract for such Component Sub-Index (or, if trading in such Index Contract has been materially suspended or materially limited, its good faith estimate of the settlement price that would have prevailed but for such suspension or limitation) at the close of trading on the Relevant Exchange for such Index Contract on the Valuation Date.

If at any time the method of calculating a Component Sub-Index or a Successor Sub-Index, or the level thereof, is changed or modified in a material respect, the Calculation Agent may make such adjustments to the Component Sub-Index or Successor Sub-Index or their respective methods of calculation as may be necessary in order to arrive at a level of a commodity index comparable to such Component Sub-Index or Successor Sub-Index, as if such changes or modifications had not been made, and the Calculation Agent will calculate the Final Index Value for such Component Sub-Index or Successor Sub-Index with reference to the Component Sub-Index or Successor Sub-Index as adjusted.

Accordingly, if the method of calculating a Component Sub-Index or a Successor Sub-Index is modified or rebased so that the level of such Component Sub-Index or Successor Sub-Index is a fraction or multiple of what it would have been if it had not been modified or rebased, then the Calculation Agent will adjust the level of such Component Sub-Index or Successor Sub-Index in order to arrive at a level of the Component Sub-Index or Successor Sub-Index as if it has not been modified or rebased.

Index Business Day: A day, as determined in good faith by the Calculation Agent, on which trading is generally conducted on the Relevant Exchange for each Index Contract underlying a Component Sub-Index.

Hypothetical Redemption Amount Payment Examples

If the Final Basket Level on the Valuation Date is greater than the Initial Basket Level, the notes will pay at maturity a Redemption Amount equal to the principal amount invested multiplied by the sum of 100% plus the product of the Basket Return multiplied by the Upside Participation Rate. If the Final Basket Level on the Valuation Date is equal to or less than the Initial Basket Level but greater than the Buffer Level, the notes will pay at maturity a Redemption Amount equal to only the principal amount invested with no additional return. If the Final Basket Level on the Valuation Date is equal to or less than the Initial Basket Level but less than the Buffer Level, the notes will pay at maturity a Redemption Amount equal to the principal amount invested multiplied by the sum of 100% plus the Basket Return plus the Protection Percentage. If the Basket Return is less than the Buffer Level (that is, the Final Basket Level has declined by more than 20.0% relative to the Initial Basket Level), an investor will lose principal in proportion to the percentage by which the decline in the Final Basket Level relative to the Initial Basket Level exceeds 20.0%. Accordingly, in such circumstances the Redemption Amount will be less than, and may be as little as, 20.0% of the principal amount invested.

Table 10 below illustrates the hypothetical Redemption Amount per $10,000 note, based on hypothetical Final Basket Levels (which will be calculated on the Valuation Date) and the consequent range for the Basket Return from −100% to 100%. Table 10 also reflects the Upside Participation Rate of 181%, the Protection Percentage of 20% and the Buffer Level of 80% of the Initial Basket Level (each of which were determined on the Trade Date). The Initial Basket Level was set at 100 on the Trade Date. The following results are based solely on the hypothetical examples cited; the Final Basket Levels have been chosen arbitrarily for the purpose of these examples and should not be taken as indicative of the future performance of the price of the Component Commodities. Numbers in the examples have been rounded for ease of analysis.

TABLE 10

| | | | Redemption Amount |
|---|---|---|---|
| Final | Initial | | (per $10,000 principal |
| Basket Level | Basket Level | Basket Return | amount)¹ |
| 200 | 100 | 100% | $28,100 |
| 190 | 100 | 90% | $26,290 |
| 180 | 100 | 80% | $24,480 |
| 170 | 100 | 70% | $22,670 |
| 160 | 100 | 60% | $20,860 |
| 150 | 100 | 50% | $19,050 |
| 140 | 100 | 40% | $17,240 |
| 130 | 100 | 30% | $15,430 |
| 120 | 100 | 20% | $13,620 |
| 110 | 100 | 10% | $11,810 |
| 100 | 100 | 0% | $10,000 |
| 90 | 100 | −10% | $10,000 |
| 80 | 100 | −20% | $10,000 |
| 70 | 100 | −30% | $9,000 |
| 60 | 100 | −40% | $8,000 |
| 50 | 100 | −50% | $7,000 |
| 40 | 100 | −60% | $6,000 |
| 30 | 100 | −70% | $5,000 |
| 20 | 100 | −80% | $4,000 |
| 10 | 100 | −90% | $3,000 |
| 0 | 100 | −100% | $2,000 |

The examples below illustrate how the Final Basket Level, the Basket Return and the Redemption Amount are calculated. The below examples are based on the Initial Index Value of each Component Sub-Index (as determined on the Trade Date) and hypothetical values for the Final Index Value of each Component Sub-Index (which will be determined on the Valuation Date). The Initial Basket Level was set to 100 on the Trade Date. The following results are based solely on the hypothetical examples cited; the Final Index Values of each Component Sub-Index and the Final Basket Levels have been chosen arbitrarily for the purpose of these examples and should not be taken as indicative of the future performance of the Component Sub-Indices. Numbers in the examples have been rounded for ease of analysis.

### EXAMPLE 1

### The Final Index Value of each Component Commodity Increases Relative to its Initial Index Value, Resulting in a Final Basket Level of 130, a Basket Return of 30% and a Redemption Amount of $15,430 per $10,000 Note

The Basket Return equals (Final Basket Level−Initial Basket Level)/Initial Basket Level, and is calculated as follows:

Basket Return=(130−100)/100

The Redemption Amount per $10,000 principal amount equals $10,000×(100% +(Basket Return x Upside Participation Rate)) and is calculated as follows:

Redemption Amount per $1,000 principal amount of notes=$10,000×(100% +(30% ×181%))=$15,430

Table 11 below illustrates how the Final Basket Level in the above example was calculated:

TABLE 11

| | Initial | Final Index | | Weighted |
|---|---|---|---|---|
| | Index Value | Value (on | | Component |
| Component | (on Trade | Valuation | | Sub-Index |
| Sub-Index | Date) | Date) | Weighting | Return |
| LBCIPB Natural | 69.4364 | 90.2673 | 10.00% | 0.0300 |
| Gas | | | | |
| LBCIPB WTI | 104.0448 | 135.2582 | 5.00% | 0.0150 |
| Crude | | | | |
| LBCIPB Brent | 102.7882 | 133.6247 | 5.00% | 0.0150 |
| Crude | | | | |
| LBCIPB Gasoline | 124.8300 | 162.2790 | 3.00% | 0.0090 |
| LBCIPB Heating | 94.7922 | 123.2299 | 2.00% | 0.0060 |
| Oil | | | | |
| LBCIPB Live | 105.4617 | 137.1002 | 4.00% | 0.0120 |
| Cattle | | | | |
| LBCIPB Lean | 105.8668 | 137.6268 | 2.00% | 0.0060 |
| Hogs | | | | |
| LBCIPB Wheat | 194.8825 | 253.3473 | 4.00% | 0.0120 |
| LBCIPB Corn | 134.3649 | 174.6744 | 6.00% | 0.0180 |
| LBCIPB | 142.7296 | 185.5485 | 7.00% | 0.0210 |
| Soybeans | | | | |
| LBCIPB Soybean | 140.0817 | 182.1062 | 3.00% | 0.0090 |
| Oil | | | | |
| LBCIPB | 103.0509 | 133.9662 | 7.50% | 0.0225 |
| Aluminum | | | | |
| LBCIPB Copper | 122.5884 | 159.3649 | 7.50% | 0.0225 |
| LBCIPB Zinc | 108.4202 | 140.9463 | 4.00% | 0.0120 |
| LBCIPB Nickel | 197.7906 | 257.1278 | 6.00% | 0.0180 |
| LBCIPB Gold | 118.2720 | 153.7536 | 9.50% | 0.0285 |
| LBCIPB Silver | 123.2873 | 160.2735 | 2.50% | 0.0075 |
| LBCIPB Sugar | 54.4007 | 70.7209 | 4.00% | 0.0120 |
| LBCIPB Cotton | 102.9430 | 133.8259 | 4.00% | 0.0120 |
| LBCIPB Coffee | 101.0169 | 131.3220 | 4.00% | 0.0120 |

| | |
|---|---|
| Sum of Weighted Component Sub-Index | 0.30 |
| Returns = | |
| Final Basket Level = 100 × (1 + Sum of | 130.0 |
| the Weighted Component Sub-Index Returns) = | |

### EXAMPLE 2

### The Final Index Value of each Component Sub-Index Decreases Relative to its Initial Index Value, Resulting in a Final Basket Level of 90, a Basket Return of −10% and a Redemption Amount of $10,000 per $10,000 Note

The Basket Return equals (Final Basket Level−Initial Basket Level)/Initial Basket Level, and is calculated as follows:

Basket Return=(90−100)/100

The Redemption Amount per $10,000 principal amount equals $10,000, because the Basket Return was less than 0.00% but greater than the Buffer Level of 80% of the Initial Basket Level.

Table 12 below illustrates how the Final Basket Level in the above example was calculated:

TABLE 12

| | Initial | Final Index | | Weighted |
|---|---|---|---|---|
| | Index Value | Value (on | | Component |
| Component | (on Trade | Valuation | | Sub-Index |
| Sub-Index | Date) | Date) | Weighting | Return |
| LBCIPB Natural | 69.4364 | 62.4928 | 10.00% | −0.0100 |
| Gas | | | | |
| LBCIPB WTI | 104.0448 | 93.6403 | 5.00% | −0.0050 |
| Crude | | | | |
| LBCIPB Brent | 102.7882 | 92.5094 | 5.00% | −0.0050 |
| Crude | | | | |
| LBCIPB Gasoline | 124.8300 | 112.3470 | 3.00% | −0.0030 |
| LBCIPB Heating | 94.7922 | 85.3130 | 2.00% | −0.0020 |
| Oil | | | | |
| LBCIPB Live | 105.4617 | 94.9155 | 4.00% | −0.0040 |
| Cattle | | | | |
| LBCIPB Lean | 105.8668 | 95.2801 | 2.00% | −0.0020 |
| Hogs | | | | |
| LBCIPB Wheat | 194.8825 | 175.3943 | 4.00% | −0.0040 |
| LBCIPB Corn | 134.3649 | 120.9284 | 6.00% | −0.0060 |
| LBCIPB | 142.7296 | 128.4566 | 7.00% | −0.0070 |
| Soybeans | | | | |
| LBCIPB Soybean | 140.0817 | 126.0735 | 3.00% | −0.0030 |
| Oil | | | | |
| LBCIPB | 103.0509 | 92.7458 | 7.50% | −0.0075 |
| Aluminum | | | | |
| LBCIPB Copper | 122.5884 | 110.3296 | 7.50% | −0.0075 |
| LBCIPB Zinc | 108.4202 | 97.5782 | 4.00% | −0.0040 |
| LBCIPB Nickel | 197.7906 | 178.0115 | 6.00% | −0.0060 |
| LBCIPB Gold | 118.2720 | 106.4448 | 9.50% | −0.0095 |
| LBCIPB Silver | 123.2873 | 110.9586 | 2.50% | −0.0025 |
| LBCIPB Sugar | 54.4007 | 48.9606 | 4.00% | −0.0040 |
| LBCIPB Cotton | 102.9430 | 92.6487 | 4.00% | −0.0040 |
| LBCIPB Coffee | 101.0169 | 90.9152 | 4.00% | −0.0040 |

| | |
|---|---|
| Sum of Weighted Component Sub-Index Returns = | −0.10 |
| Final Basket Level = 100 × (1 + Sum of | 90.0 |
| the Weighted Component Commodity Returns) = | |

### EXAMPLE 3

### The Final Index Value of each Component Sub-Index Decreases Relative to its Initial Index Value, Resulting in a Final Basket Level of 60, a Basket Return of −40% and a Redemption Amount of $8,000 per $10,000 Note

The Basket Return equals (Final Basket Level−Initial Basket Level)/Initial Basket Level, and is calculated as follows:

Basket Return=(60−100)/100

The Redemption Amount per $10,000 principal amount equals $10,000×(100% +(Basket Return+Protection Percentage)) and is calculated as follows:

Redemption Amount per $10, 000 principal amount of notes=$10,000×(100% +((−40% +20%))=$88,000

Table 13 illustrates how the Final Basket Level in the above example was calculated:

TABLE 13

| | Initial | Final Index | | Weighted |
|---|---|---|---|---|
| | Index Value | Value (on | | Component |
| Component | (on Trade | Valuation | | Sub-Index |
| Sub-Index | Date) | Date) | Weighting | Return |
| LBCIPB Natural | 69.4364 | 41.6618 | 10.00% | −0.0400 |
| Gas | | | | |
| LBCIPB WTI | 104.0448 | 62.4269 | 5.00% | −0.0200 |
| Crude | | | | |
| LBCIPB Brent | 102.7882 | 61.6729 | 5.00% | −0.0200 |
| Crude | | | | |
| LBCIPB Gasoline | 124.8300 | 74.8980 | 3.00% | −0.0120 |
| LBCIPB Heating | 94.7922 | 56.8753 | 2.00% | −0.0080 |
| Oil | | | | |
| LBCIPB Live | 105.4617 | 63.2770 | 4.00% | −0.0160 |
| Cattle | | | | |
| LBCIPB Lean | 105.8668 | 63.5201 | 2.00% | −0.0080 |
| Hogs | | | | |
| LBCIPB Wheat | 194.8825 | 116.9295 | 4.00% | −0.0160 |
| LBCIPB Corn | 134.3649 | 80.6189 | 6.00% | −0.0240 |
| LBCIPB | 142.7296 | 85.6378 | 7.00% | −0.0280 |
| Soybeans | | | | |
| LBCIPB Soybean | 140.0817 | 84.0490 | 3.00% | −0.0120 |
| Oil | | | | |
| LBCIPB | 103.0509 | 61.8305 | 7.50% | −0.0300 |
| Aluminum | | | | |
| LBCIPB Copper | 122.5884 | 73.5530 | 7.50% | −0.0300 |
| LBCIPB Zinc | 108.4202 | 65.0521 | 4.00% | −0.0160 |
| LBCIPB Nickel | 197.7906 | 118.6744 | 6.00% | −0.0240 |
| LBCIPB Gold | 118.2720 | 70.9632 | 9.50% | −0.0380 |
| LBCIPB Silver | 123.2873 | 73.9724 | 2.50% | −0.0100 |
| LBCIPB Sugar | 54.4007 | 32.6404 | 4.00% | −0.0160 |
| LBCIPB Cotton | 102.9430 | 61.7658 | 4.00% | −0.0160 |
| LBCIPB Coffee | 101.0169 | 60.6101 | 4.00% | −0.0160 |

| | |
|---|---|
| Sum of Weighted Component Sub-Index Returns = | −0.40 |
| Final Basket Level = 100 × (1 + Sum of | 60.0 |
| the Weighted Component Commodity Returns) = | |

### EXAMPLE 4

### The Final Index Values of Certain Component Sub-Indices Appreciate Relative to Their Respective Initial Index Values, While the Final Index Values of the Other Component Sub-Indices Depreciate Relative to Their Respective Initial Index Values, Resulting in a Final Basket Level of 110, a Basket Return of 10% and a Redemption Amount of $11,810 per $10,000 Note

The Basket Return equals (Final Basket Level−Initial Basket Level)/Initial Basket Level, and is calculated as follows:

Basket Return=(110−100)/100

The Redemption Amount per $10,000 principal amount equals $10,000×(100% +(Basket Return×Upside Participation Rate)) and is calculated as follows:

Redemption Amount per $10, 000 principal amount of notes=$10,000×(100% +(10% ×181%))=$11,810

Table 14 illustrates how the Final Basket Level in the above example was calculated:

TABLE 14

| | Initial | Final Index | | Weighted |
|---|---|---|---|---|
| | Index Value | Value (on | | Component |
| Component | (on Trade | Valuation | | Sub-Index |
| Sub-Index | Date) | Date) | Weighting | Return |
| LBCIPB Natural | 69.4364 | 88.0031 | 10.00% | 0.0267 |
| Gas | | | | |
| LBCIPB WTI | 104.0448 | 131.8655 | 5.00% | 0.0134 |
| Crude | | | | |
| LBCIPB Brent | 102.7882 | 130.2729 | 5.00% | 0.0134 |
| Crude | | | | |
| LBCIPB Gasoline | 124.8300 | 103.9345 | 3.00% | −0.0050 |
| LBCIPB Heating | 94.7922 | 78.9248 | 2.00% | −0.0033 |
| Oil | | | | |
| LBCIPB Live | 105.4617 | 133.6612 | 4.00% | 0.0107 |
| Cattle | | | | |
| LBCIPB Lean | 105.8668 | 134.1747 | 2.00% | 0.0053 |
| Hogs | | | | |
| LBCIPB Wheat | 194.8825 | 162.2609 | 4.00% | −0.0067 |
| LBCIPB Corn | 134.3649 | 170.2929 | 6.00% | 0.0160 |
| LBCIPB | 142.7296 | 118.8379 | 7.00% | −0.0117 |
| Soybeans | | | | |
| LBCIPB Soybean | 140.0817 | 116.6332 | 3.00% | −0.0050 |
| Oil | | | | |
| LBCIPB | 103.0509 | 130.6058 | 7.50% | 0.0201 |
| Aluminum | | | | |
| LBCIPB Copper | 122.5884 | 155.3675 | 7.50% | 0.0201 |
| LBCIPB Zinc | 108.4202 | 137.4108 | 4.00% | 0.0107 |
| LBCIPB Nickel | 197.7906 | 164.6822 | 6.00% | −0.0100 |
| LBCIPB Gold | 118.2720 | 98.4743 | 9.50% | −0.0159 |
| LBCIPB Silver | 123.2873 | 156.2533 | 2.50% | 0.0067 |
| LBCIPB Sugar | 54.4007 | 68.9470 | 4.00% | 0.0107 |
| LBCIPB Cotton | 102.9430 | 130.4691 | 4.00% | 0.0107 |
| LBCIPB Coffee | 101.0169 | 84.1075 | 4.00% | −0.0067 |

| | |
|---|---|
| Sum of Weighted Component Sub-Index Returns = | 0.10 |
| Final Basket Level = 100 × (1 + Sum of | 110.0 |
| the Weighted Component Commodity Returns) = | |

### EXAMPLE 5

### The Final Index Values of Certain Component Sub-Indices Appreciate Relative to Their Respective Initial Index Values, While the Final Index Values of the Other Component Sub-Indices Depreciate Relative to Their Respective Initial Index Values, Resulting in a Final Basket Level of 80, a Basket Return of −20% and a Redemption Amount of $10,000 per $10,000 Note

The Basket Return equals (Final Basket Level−Initial Basket Level)/Initial Basket Level, and is calculated as follows:

Basket Return=(80−100)/100

The Redemption Amount per $10,000 principal amount equals $10,000, because the Basket Return was less than 0.00% but equal to the Buffer Level of 80% of the Initial Basket Level.

Table 15 illustrates how the Final Basket Level in the above example was calculated:

TABLE 15

| | Initial | Final Index | | Weighted |
|---|---|---|---|---|
| | Index Value | Value (on | | Component |
| Component | (on Trade | Valuation | | Sub-Index |
| Sub-Index | Date) | Date) | Weighting | Return |
| LBCIPB Natural | 69.4364 | 12.8953 | 10.00% | −0.0814 |
| Gas | | | | |
| LBCIPB WTI | 104.0448 | 19.3226 | 5.00% | −0.0407 |
| Crude | | | | |
| LBCIPB Brent | 102.7882 | 165.9295 | 5.00% | 0.0307 |
| Crude | | | | |
| LBCIPB Gasoline | 124.8300 | 201.5113 | 3.00% | 0.0184 |
| LBCIPB Heating | 94.7922 | 17.6043 | 2.00% | −0.0163 |
| Oil | | | | |
| LBCIPB Live | 105.4617 | 19.5857 | 4.00% | −0.0326 |
| Cattle | | | | |
| LBCIPB Lean | 105.8668 | 170.8993 | 2.00% | 0.0123 |
| Hogs | | | | |
| LBCIPB Wheat | 194.8825 | 36.1925 | 4.00% | −0.0326 |
| LBCIPB Corn | 134.3649 | 216.9033 | 6.00% | 0.0369 |
| LBCIPB | 142.7296 | 26.5069 | 7.00% | −0.0570 |
| Soybeans | | | | |
| LBCIPB Soybean | 140.0817 | 226.1319 | 3.00% | 0.0184 |
| Oil | | | | |
| LBCIPB | 103.0509 | 19.1380 | 7.50% | −0.0611 |
| Aluminum | | | | |
| LBCIPB Copper | 122.5884 | 22.7664 | 7.50% | −0.0611 |
| LBCIPB Zinc | 108.4202 | 175.0212 | 4.00% | 0.0246 |
| LBCIPB Nickel | 197.7906 | 36.7325 | 6.00% | −0.0489 |
| LBCIPB Gold | 118.2720 | 190.9248 | 9.50% | 0.0584 |
| LBCIPB Silver | 123.2873 | 199.0209 | 2.50% | 0.0154 |
| LBCIPB Sugar | 54.4007 | 87.8183 | 4.00% | 0.0246 |
| LBCIPB Cotton | 102.9430 | 19.1180 | 4.00% | −0.0326 |
| LBCIPB Coffee | 101.0169 | 163.0701 | 4.00% | 0.0246 |

| | |
|---|---|
| Sum of Weighted Component Sub-Index Returns = | −0.20 |
| Final Basket Level = 100 × (1 + Sum of | 80.0 |
| the Weighted Component Commodity Returns) = | |

### EXAMPLE 6

### The Final Index Values of Certain Component Sub-Indices Appreciate Relative to Their Respective Initial Index Values, while the Final Index Values of the Other Component Sub-Indices Depreciate Relative to Their Respective Initial Index Values, Resulting in a Final Basket Level of 70, a Basket Return of −30% and a Redemption Amount of $9,000 per $10,000 Note

The Basket Return equals (Final Basket Level−Initial Basket Level)/Initial Basket Level, and is calculated as follows:

Basket Return=(70−100)/100

The Redemption Amount per $1,000 principal amount equals $10,000×(100% +(Basket Return+Protection Percentage)) and is calculated as follows:

Redemption Amount per $10,000 principal amount of notes=$10,000×(100% +(−30% +20%))=$9,000

Table 16 illustrates how the Final Basket Level in the above example was calculated:

TABLE 16

| | Initial | Final Index | | Weighted |
|---|---|---|---|---|
| | Index Value | Value (on | | Component |
| Component | (on Trade | Valuation | | Sub-Index |
| Sub-Index | Date) | Date) | Weighting | Return |
| LBCIPB Natural | 69.4364 | 18.9615 | 10.00% | −0.0727 |
| Gas | | | | |
| LBCIPB WTI | 104.0448 | 28.4122 | 5.00% | −0.0363 |
| Crude | | | | |
| LBCIPB Brent | 102.7882 | 28.0691 | 5.00% | −0.0363 |
| Crude | | | | |
| LBCIPB Gasoline | 124.8300 | 178.1228 | 3.00% | 0.0128 |
| LBCIPB Heating | 94.7922 | 135.2612 | 2.00% | 0.0085 |
| Oil | | | | |
| LBCIPB Live | 105.4617 | 28.7992 | 4.00% | −0.0291 |
| Cattle | | | | |
| LBCIPB Lean | 105.8668 | 151.0638 | 2.00% | 0.0085 |
| Hogs | | | | |
| LBCIPB Wheat | 194.8825 | 53.2179 | 4.00% | −0.0291 |
| LBCIPB Corn | 134.3649 | 191.7284 | 6.00% | 0.0256 |
| LBCIPB | 142.7296 | 38.9762 | 7.00% | −0.0509 |
| Soybeans | | | | |
| LBCIPB Soybean | 140.0817 | 38.2531 | 3.00% | −0.0218 |
| Oil | | | | |
| LBCIPB | 103.0509 | 28.1408 | 7.50% | −0.0545 |
| Aluminum | | | | |
| LBCIPB Copper | 122.5884 | 33.4761 | 7.50% | −0.0545 |
| LBCIPB Zinc | 108.4202 | 154.7073 | 4.00% | 0.0171 |
| LBCIPB Nickel | 197.7906 | 54.0120 | 6.00% | −0.0436 |
| LBCIPB Gold | 118.2720 | 168.7650 | 9.50% | 0.0406 |
| LBCIPB Silver | 123.2873 | 175.9215 | 2.50% | 0.0107 |
| LBCIPB Sugar | 54.4007 | 77.6256 | 4.00% | 0.0171 |
| LBCIPB Cotton | 102.9430 | 28.1114 | 4.00% | −0.0291 |
| LBCIPB Coffee | 101.0169 | 144.1433 | 4.00% | 0.0171 |

| | |
|---|---|
| Sum of Weighted Component Sub-Index | −0.30 |
| Returns = | |
| Final Basket Level = 100 × (1 + Sum of | 70.0 |
| the Weighted Component Commodity Returns) = | |

Historical Component Sub-Index Levels and Basket Return

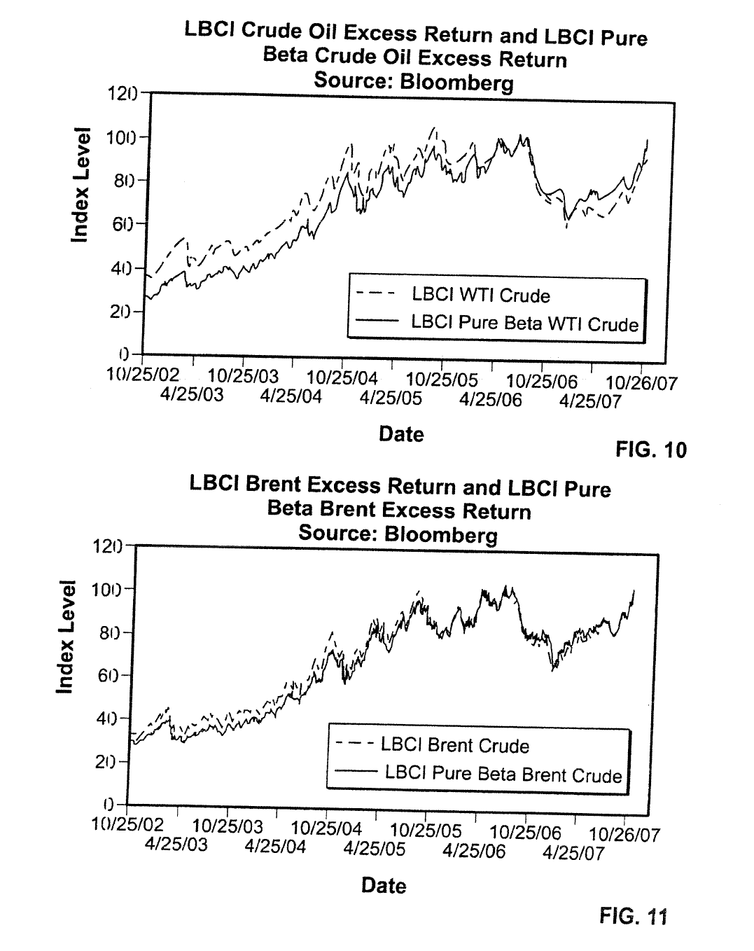

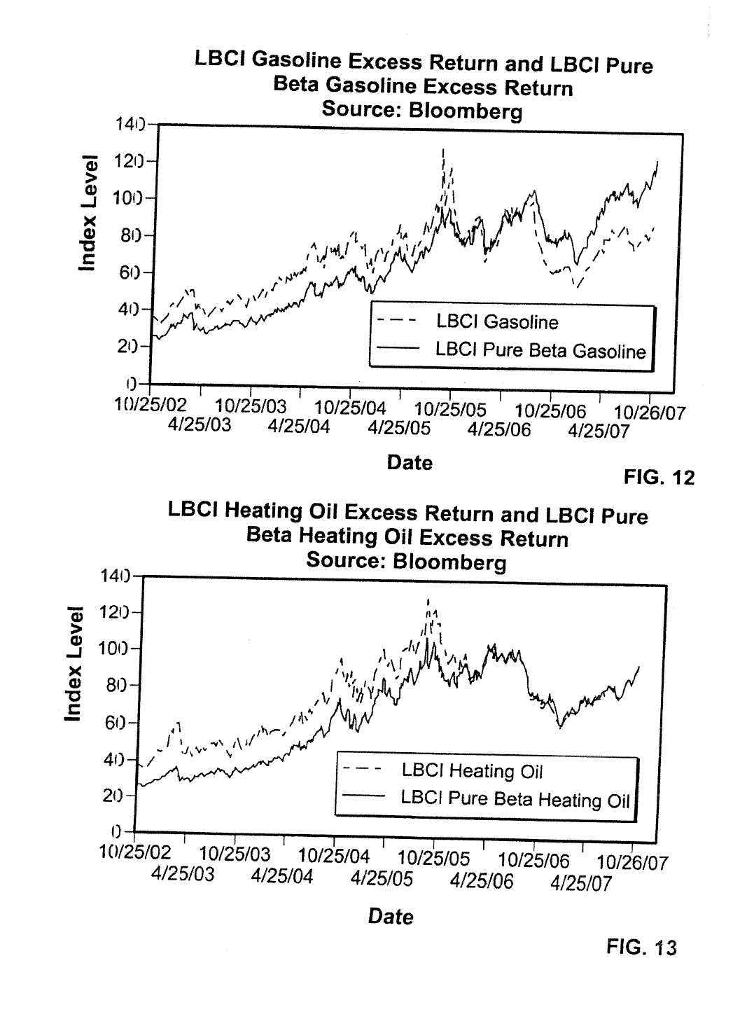

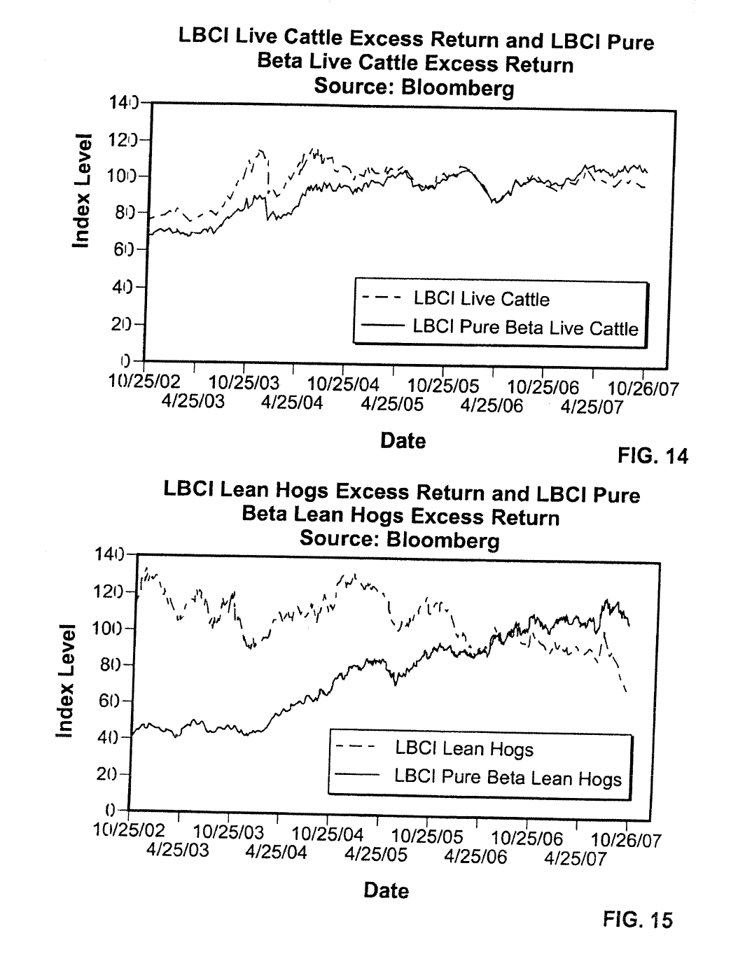

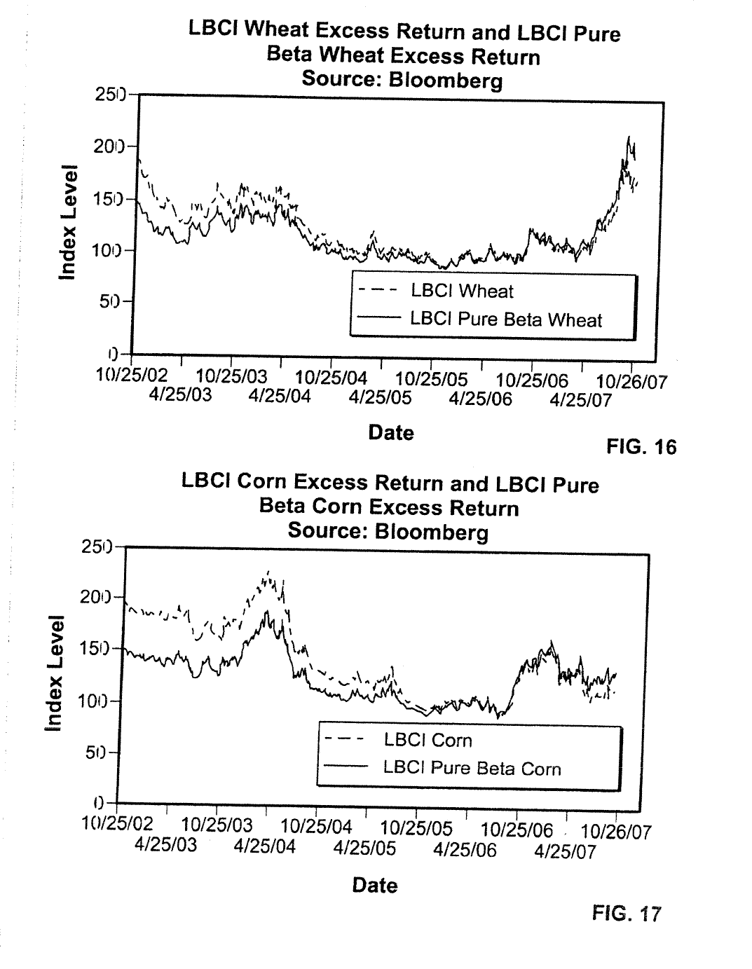

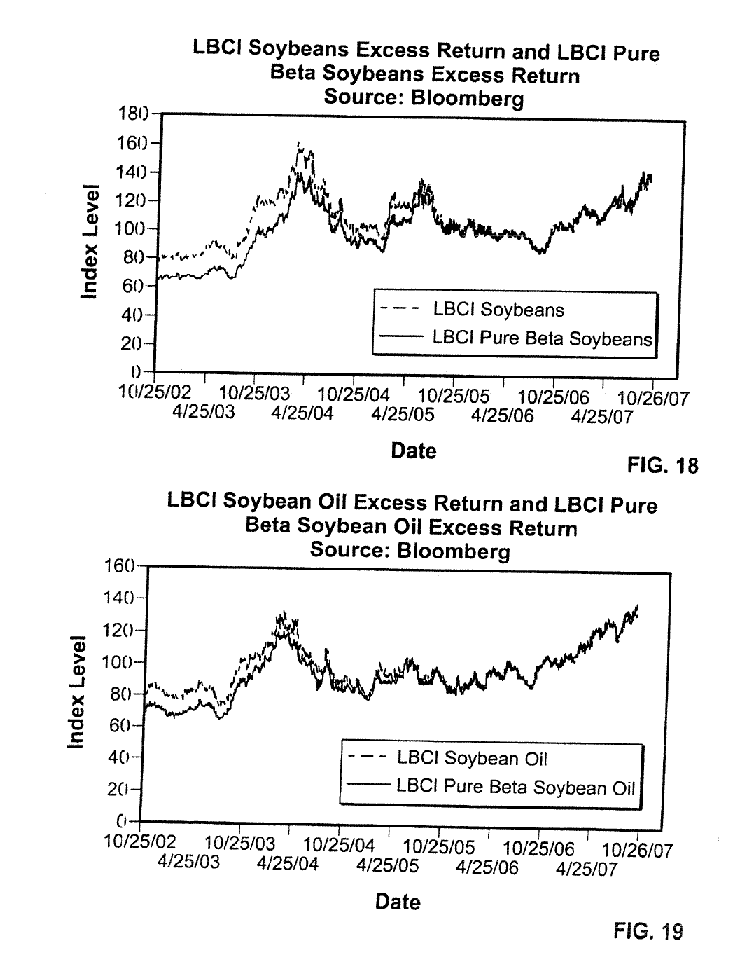

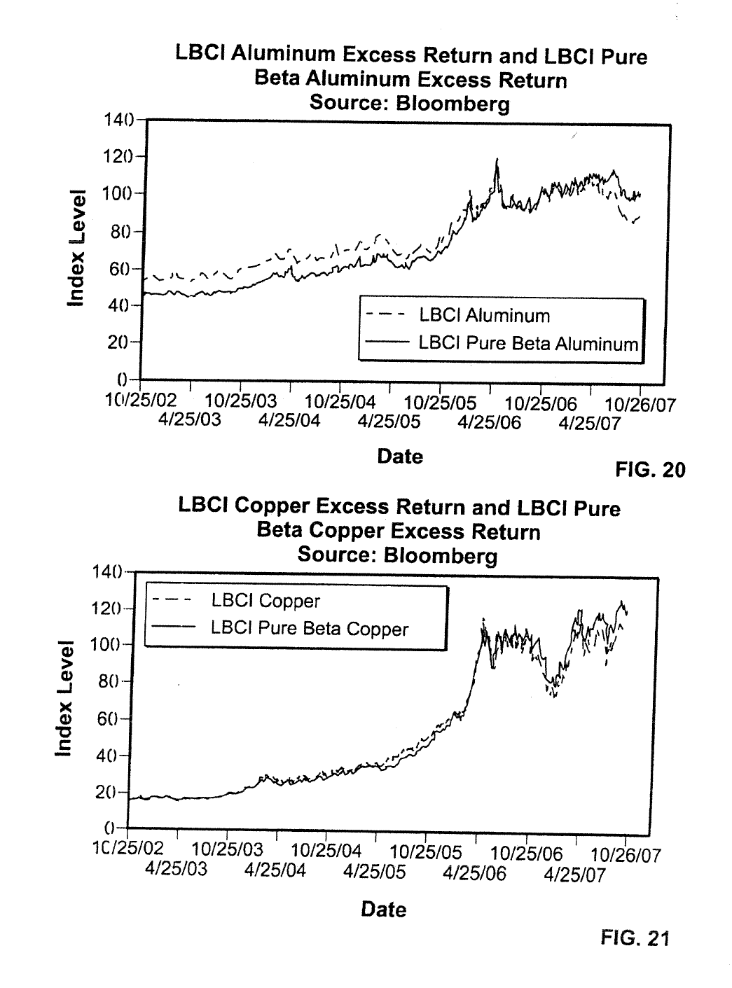

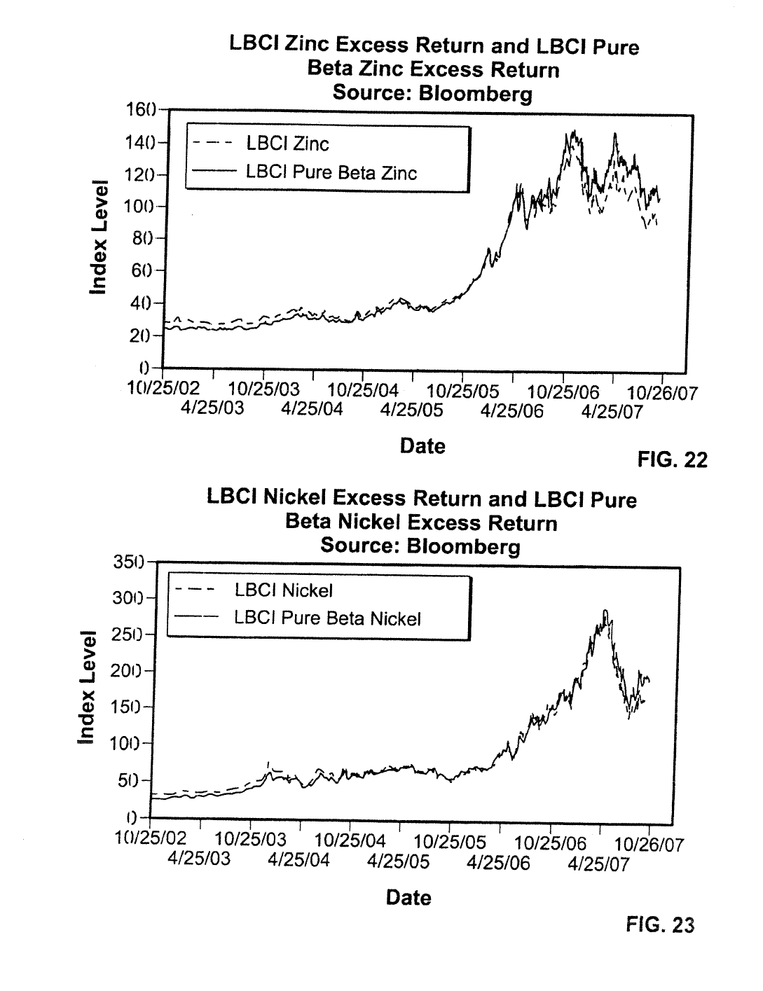

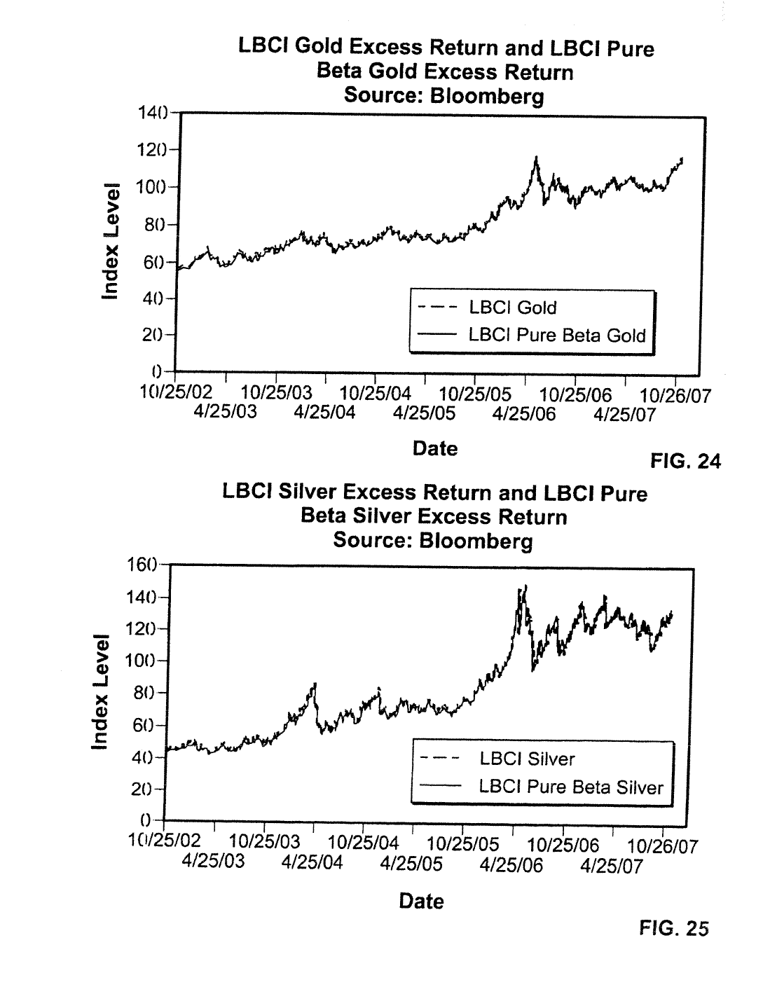

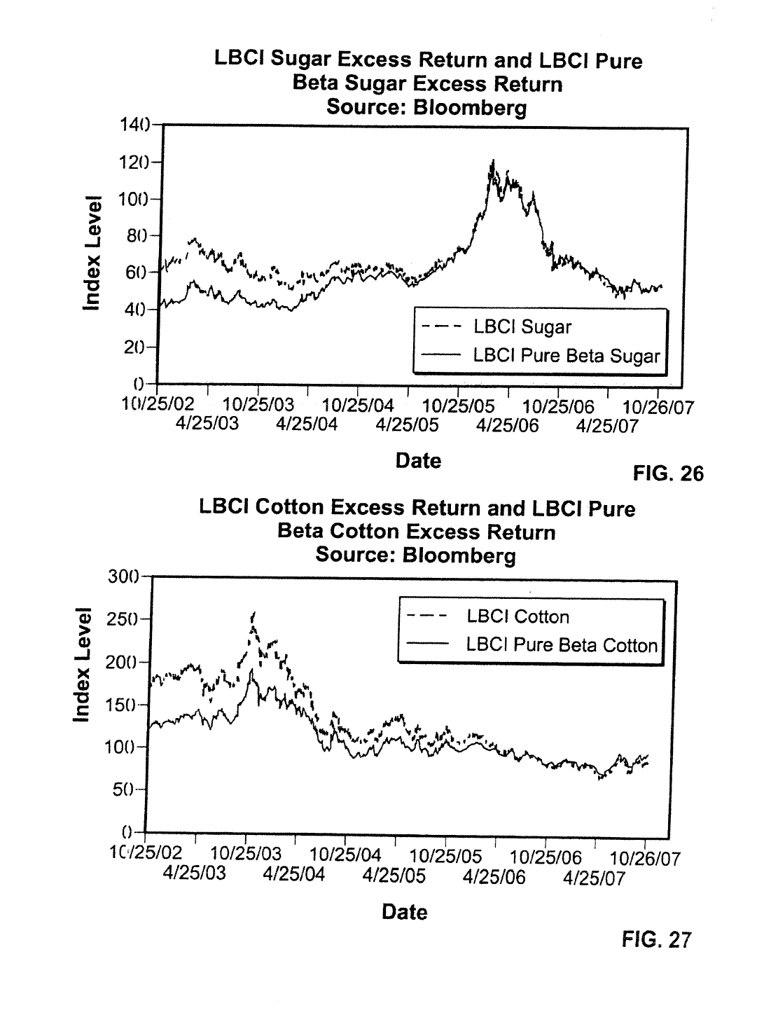

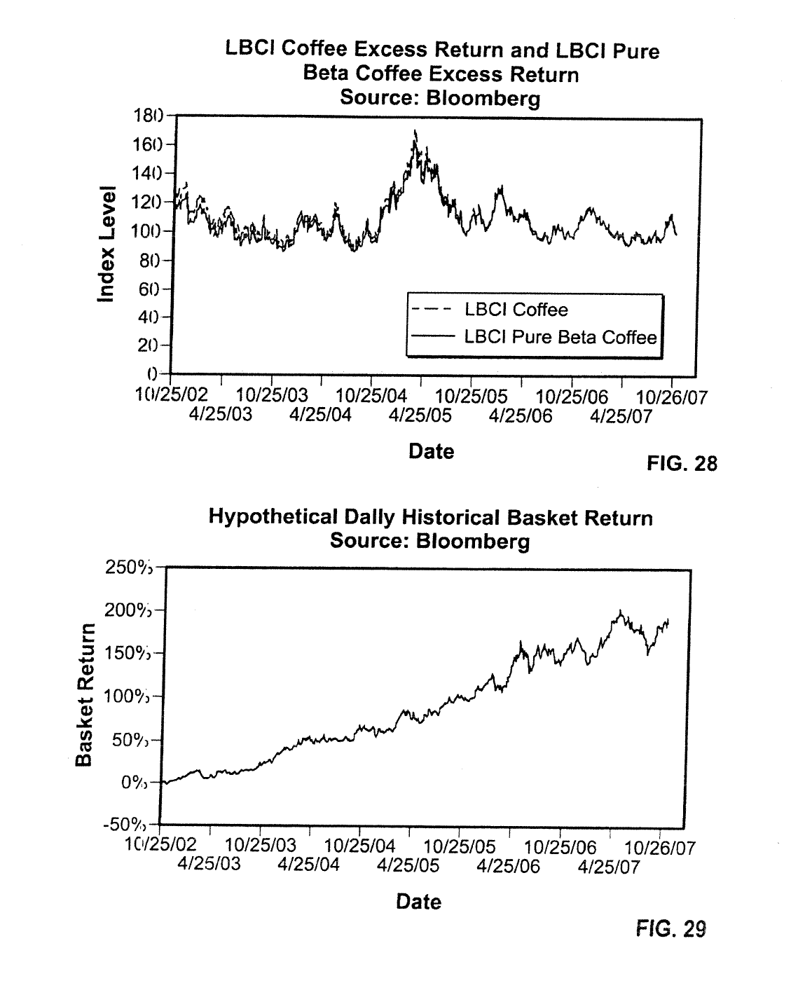

As the Component Sub-Indices were launched on Oct. 10, 2007, the Component Sub-Indices have little or no trading history and very limited actual historical information on the performance of the Component Sub-Indices is available. FIG. 9-28 show, for each Component Sub-Index, (a) hypothetical daily historical levels for that Component Sub-Index from Oct. 25, 2002, to Oct. 10, 2007, calculated based on the level for the Component Sub-Index that was set to 100 on Jun. 30, 2006, and using the same objective criteria as will be used by the Component Sub-Index going forward, as well as actual observable data for the Index Contract underlying that Component Sub-Index; and (b) actual historical levels for each that Component Sub-Index from Oct. 10, 2007, to Oct. 26, 2007.

Each Component Sub-Index of an embodiment is a single-commodity sub-index of, and follows the methodologies of, the PBCI (except for the PBCI Brent, which is the PBCI variant of the LBCI Brent). The PBCI is itself a variant of the general LBCI and differs from the general LBCI in certain significant ways, including the re-allocation methodologies. For comparison purposes only, FIGS. 9-28 also show the hypothetical and actual daily historical levels of the single-commodity excess return sub-indices of the general LBCI and of the LBCI Brent (collectively, the “LBCI sub-indices”) that correspond to each Component Sub-Index. The LBCI sub-index levels in FIGS. 9-28 reflect (a) hypothetical daily historical levels from Oct. 25, 2002 to Jul. 1, 2006 (except that, for LBCI Brent, the hypothetical daily historical levels are from Oct. 25, 2002 to Jul. 12, 2007), calculated based on the level for the LBCI sub-index that was set to 100 on Jun. 30, 2006, and using the same objective criteria used by the LBCI sub-index going forward, as well as actual observable data for the Index Contract underlying that LBCI sub-index and (b) actual historical levels for the LBCI sub-index from Jul. 1, 2006 to Oct. 26, 2007 (except that, for LBCI Brent, the actual historical levels are from Jul. 12, 2007 to Oct. 26, 2007).

FIG. 29 shows hypothetical daily historical Basket Return based on the hypothetical composite performance of the Index Values for the Component Sub-Indices, using (a) hypothetical daily historical levels for each of the Component Sub-Indices from Oct. 25, 2002, to Oct. 10, 2007, calculated based on the level of each Component Sub-Index that was set to 100 on Jun. 30, 2006, and using the same objective criteria as will be used by each of the Component Sub-Indices going forward, as well as actual observable data for the Index Contracts; and (b) actual historical levels for each the Component Sub-Indices from Oct. 10, 2007, to Oct. 26, 2007. For purposes of illustration only, the Basket Return shown in FIG. 29 was based on an Initial Basket Level indexed to a level of 0.0 on Oct. 25, 2002, based upon the Index Values for the Component Sub-Indices on that day, and the composite value of the Component Sub-Indices on any subsequent day was obtained by using the calculation of the Basket Return described above.

Under the terms of the notes and for purposes of calculating the Redemption Amount, the Initial Basket Level will be indexed to a level of 0.0 on the Trade Date, based on the Initial Index Values for the Component Sub-Indices on the Trade Date.

### Pure Beta Component Sub-Indices

Each Component Sub-Index, other than PBCI Brent, represents a single-commodity excess return element of the PBCI, and is comprised solely of the individual Index Contract on the Relevant Exchange.

The methodologies for, and calculation of the return for, each Component Sub-Index is the same in all respects to the PBCI except that each Component Sub-Index is a single-commodity component of the PBCI (other than PBCI Brent, which is the PBCI variant of the LBCI Brent), and therefore the daily index weighting of that Component Sub-Index is always 100%. Each Component Sub-Index was launched on Oct. 10, 2007, in conjunction with the launch of the PBCI, and the level of each Component Sub-Index was set to 100 as of Jun. 30, 2006, to correspond to the level of each single-commodity excess return sub-indices of the general LBCI (and LBCI Brent), each of which was also set to 100 on Jun. 30, 2006.

Calculation of the Daily Index Level

Each Component Sub-Index reflects the notional excess returns of an unleveraged investment in the corresponding Index Contract following the PBCI re-allocation methodology described under “The Lehman Brothers Commodity Index—Pure Beta” below. The “excess returns” of the Index are the combined return of spot price movements and roll yield associated with the Index Contract, each as discussed below. The final level for each Component Sub-Index for each LBCI Business Day is published on Bloomberg. The Bloomberg symbols are as shown in Table 17:

TABLE 17

| COMPONENT SUB-INDEX | BLOOMBERG SYMBOL |
|---|---|
| LBCIPB Natural Gas | LPNGER |
| LBCIPB WTI Crude | LPCLER |
| LBCIPB Brent Crude | LPCOER |
| LBCIPB Gasoline | LPUGER |
| LBCIPB Heating Oil | LPHOER |
| LBCIPB Live Cattle | LPLCER |
| LBCIPB Lean Hogs | LPLHER |
| LBCIPB Wheat | LPBWER |
| LBCIPB Corn | LPBCER |
| LBCIPB Soybeans | LPBSER |
| LBCIPB Soybean Oil | LPBOER |
| LBCIPB Aluminum | LPIAER |
| LBCIPB Copper | LPLPER |
| LBCIPB Zinc | LPLXER |
| LBCIPB Nickel | LPLNER |
| LBCIPB Gold | LPGDER |
| LBCIPB Silver | LPSIER |
| LBCIPB Sugar | LPSBER |
| LBCIPB Cotton | LPCTER |
| LBCIPB Coffee | LPKCER |
| LBCIPB Natural Gas | LPNGER |

Quarterly Re-Allocation to Forward Allocations

Each Component Sub-Index re-allocates on a quarterly basis to one of twelve series of forward contracts in the standard LBCI Contract Calendar of successive one-month increments, or “Forward Allocations”. The next Forward Allocation for each commodity is selected quarterly on the 22nd of each January, April, July and October (or if the 22nd is not an LBCI Business Day, the next LBCI Business Day) (each such day a “Re-allocation Date”), and the selection is based on the correlations in the immediately preceding quarterly period ending on the Re-allocation Date between the daily Forward Allocation Returns for each of the then-active contracts in the twelve Forward Allocations for that commodity, and the daily Effective Spot Price Returns for that commodity, each as described below under “The Lehman Brothers Commodity Index—Pure Beta—Quarterly Re-Allocation to Forward Allocations”.

Re-Allocation Roll Mechanics

Once a Forward Allocation has been selected for an Index Contract on a Re-allocation Date using the methodology above, the Component Sub-Index then rolls between the previous Forward Allocation and the new Forward Allocation. The roll period for the Forward Allocations will begin on the first LBCI Business Day after the Re-Allocation Date (that is, the 23rd of each January, April, July and October, unless such day is not an LBCI Business Day) and continue for ten LBCI Business Days. During the roll period, the hypothetical position in the Index Contract is gradually shifted from the active (or “prompt”) contract in the current Forward Allocation to the contract in the new Forward Allocation in 10% daily increments. During the re-allocation roll, the return for each Index Contract will be a composite of the prompt Index Contract under the previous Forward Allocation and the prompt Index Contract under the new Forward Allocation, weighted by the percentage that has been rolled at the end of the applicable LBCI Business Day. The quarterly re-allocation roll, however, also overlaps the monthly roll mechanic under which the Index Contracts are rolled forward to a new contract as they approach their settlement date. The result, therefore, is a blending of the roll periods for each of the Index Contracts during each quarterly re-allocation roll period.

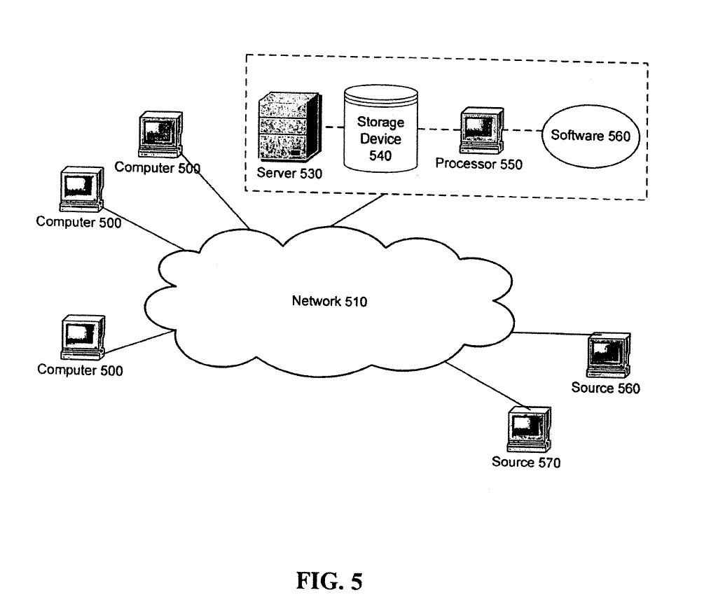

Embodiments of the present invention comprise computer components and computer-implemented steps that will be apparent to those skilled in the art. For example, calculations and communications can be performed electronically. An exemplary system is depicted in FIG. 5. As shown, computers 500 communicate via network 510 with a central server 530. A plurality of sources of data 560, 570 relating to, for example, trading volume data, also communicate via network 510 with a central server 530, processor 550, and/or other component to calculate and transmit, for example, volume forecast data. The server 530 may be coupled to one or more storage devices 540, one or more processors 550, and software 560.

Other components and combinations of components may also be used to support processing data or other calculations described herein as will be evident to those skilled in the art. Server 530 may facilitate communication of data from a storage device 540 to and from processor 550, and communications to computers 500. Processor 550 may optionally include local or networked storage (not shown) which may be used to store temporary information. Software 560 can be installed locally at a computer 500, processor 550 and/or centrally supported for facilitating calculations and applications.

For ease of exposition, not every step or element of the present invention is described herein as part of a computer system and/or software, but those skilled in the art will recognize that each step or element may have (and typically will have) a corresponding computer system or software component. Such computer system and/or software components are therefore enabled by describing their corresponding steps or elements (that is, their functionality), and are within the scope of the present invention.

Moreover, where a computer system is described or claimed as having a processor for performing a particular function, it will be understood by those skilled in the art that such usage should not be interpreted to exclude systems where a single processor, for example, performs some or all of the tasks delegated to the various processors. That is, any combination of, or all of, the processors specified in the description and/or claims could be the same processor. All such combinations are within the scope of the invention.

The present invention has been described by way of example only, and the invention is not limited by the specific embodiments described herein. As will be recognized by those skilled in the art, improvements and modifications may be made to the invention and the illustrative embodiments described herein without departing from the scope or spirit of the invention.

In the Appendices below: Appendix 1 is a table showing a summary of exemplary commodity index products; Appendix 2 is a list of definitions of certain terms used in this description; Appendix 3 contains an exemplary term sheet for buffered return enhanced notes linked to a basket of PBCI excess return sub-indices; Appendix 4 is a description of the LBCI; and Appendix 5 is a table showing the 2007 LBCI Contract Calendar.

APPENDIX 1
Summary of Commodity Index Products

| | BB Total | | |
|---|---|---|---|
| | Return Index | | |
| Index Name | Symbol | Index Description | Roll Description |
| Lehman Brothers | LBCITR | Launched July 2006, 20 components. | Rolls take place between the |
| Commodity Index | | Weighted based on liquidity as measured | fifth and ninth business days |
| | | by daily volume | each month. |
| | | of contracts traded over trailing three-year | |
| | | period. Reweighted yearly using trailing 3- | |
| | | year average | |
| | | daily liquidity, rebalanced yearly. | |
| Dow Jones-AIG | DJAIGTR | Launched 1998, 19 components. Weighted | Rolls take place between the |
| Commodities Index | | based | sixth and tenth business days |
| | | on liquidity and production over last 5 | each month. |
| | | years. Reweighted and rebalanced annually | |
| | | in January. | |
| Goldman Sachs | SPGCCITR | Launched 1991, 24 components. Weighted | Rolls take place between the |
| Commodity Index | | based | fifth and ninth business days |
| | | on global production. Heavily weighted | each month. |
| | | toward energy, re-balanced yearly. | |
| UBS Bloomberg | CMCITR1Y | Launched January 2007, 28 components. | Continuous roll (“Constant |
| Constant Maturity | | Weighted using global economic weights | Maturity Approach”) differs |
| Commodity Index | | (GDP, PPI, CPI) and global consumption | from front-month rolls. Holds |
| (CMCI) Family | | (⅔) and liquidity (open interest and | two contracts simultaneously |
| | | market volume) (⅓). About half weighted | and adjusts proportions |
| | | toward 3-month contract, weighting | relative to time to maturity. |
| | | successively decreases with expiration | |
| | | time. Reweighted in May and November | |
| | | and rebalanced monthly. Tenors range | |
| | | from 3 months to 5 years. | |
| DCI BNP Paribas | DCIBGLTR | Launched April 2007, 45 components. | Uses “Forward Curve Roll |
| Enhanced TR Index | | Weighted based on ⅓ trade volume and | optimization” process for 17 |
| | | ⅔ liquidity | contracts. Rolled on the last 3 |
| | | (market value and market interest). This | business days of month. “The |
| | | index is | roll optimization process is |
| | | a replication of the DCI with an added | achieved via an algorithm |
| | | algorithm. Reweighted annually, | which is designed to select the |
| | | rebalanced monthly. | optimum contracts on which |
| | | | the index will roll every |
| | | | month.” |
| Diapason | DCI TRUS | Launched June 2006, 45 components, | Rolls take place on the last 3 |
| Commodities Index | | selected using World Trade Significance | business days each month. |
| | | (⅓) and World Contract Liquidity (⅔). | |
| | | Re-weighted yearly in December, | |
| | | rebalanced monthly. Lists both U.S. | |
| | | and European versions of sugar and coffee, | |
| | | Tokyo non-GM soy contract, coal, | |
| | | electricity, and | |
| | | ethanol futures. | |
| Merrill Lynch | MLCXTR | Launched June 2006, 18 components. | Semicontinuous contract |
| Commodity index | | Commodity contracts are initially selected | rolling schedule. Futures |
| eXtra | | by liquidity and then weighted by the | contracts included in the Index |
| | | importance of each commodity in the | are rolled from the first |
| | | global economy, with particular emphasis | through 15th business day. |
| | | on downstream commodities. | Uses second-to-third month |
| | | | roll instead of front-to-second. |
| The Brookshire | BIRMIUSD | 26 components. Weighted using | |
| International Raw | | consumption | |
| Materials Index | | levels, no reweighting changes, rebalanced | |
| | | monthly. | |
| Reuters/Jefferies CRB | CRYTR | Started 1957, relaunched 2005, 19 | Rolls take place between the |
| Index | | components. | first and fourth business days |
| | | 4-tier weighting system. Rebalanced | each month. |
| | | monthly. | |
| Deutsche Bank Liquid | DBLCMAVL | Launched 2003, six components. Few | Rolls take place between 2nd |
| Commodity Index | | rebalancing changes. Rebalances energy | and 6th business days each |
| | | futures monthly, | month. An “Optimum Yield” |
| | | other positions annually in November. | version is available (DBLCI- |
| | | | OY), which selects new |
| | | | contract based on maximum |
| | | | implied roll yield. |
| Rogers International | RICIGLTR | Launched 1998, 36 components. Weighted | “On the close of the last |
| Commodities Index | | based | Business Day of each month, |
| | | on consumption. No reweighting changes. | all the futures contracts used |
| | | Rebalanced monthly. | to calculate the RICI, except |
| | | | for the contracts traded on the |
| | | | London Metal Exchange, are |
| | | | rolled.” |

Appendix 2: Definitions

Forward Allocation: For a given commodity the date is shifted forward by a specific number of months (0-12 as per the Investment Horizon). The active front and back contracts are then evaluated using the LBCI schedule with this forward date. For example, Forward Allocation1 is the LBCI roll calendar, Forward Allocation2 is the current LBCI roll calendar plus 1.

Effective Spot Price: The average price for each Forward Allocation within the Investment Horizon, weighted by Open Interest.

Investment Horizon: 0-12 months.

Tracking Mark: The correlation between the three months returns of the Effective Spot Price and a given Forward Allocation, for the period between the last rebalancing and the day prior to the new rebalancing.

Allocation Restriction: At the quarterly rebalancing, the Forward Allocations for which Open Interest is less than 7% of the previous 3 months average total Open Interest for the Investment Horizon on the preceding day will not be considered.

Appendix 3: Exemplary Term Sheet for Buffered Return Enhanced Notes Linked to a Basket of PBCI Excess Return Sub-Indices

Issuer: Lehman Brothers Holdings Inc. (A+/A1)

Principal Amount: U.S. $144,330,000

CUSIP: 52517P6P1

Trade Date: Oct. 26, 2007

Issue Date: Nov. 2, 2007

Maturity Date: Nov. 2, 2011, or if such date is not a Business Day, the next succeeding Business Day.

Valuation Date: Oct. 26, 2011, or if such date is not an Index Business Day, the immediately preceding Index Business Day; provided that, if a Market Disruption Event is in effect on the scheduled Valuation Date, the Valuation Date may be postponed (as described below under “Market Disruption Events”).

Issue Price: 100%

Interest: The notes do not bear interest.

Component Sub-Indices and Indices and Component Weightings: The notes are linked to a Basket consisting of the Component Sub-Indices. Each Component Sub-index is calculated and published by the Index Sponsor, subject to adjustment in accordance with Index Adjustment below. For further information on the Component Sub-Indices see “The Lehman Brothers Commodity Index—Pure Beta Component Sub-Indices” below).

The Component Sub-Indices and the Component Weighting for each Component Sub-Index are as set forth below:

| | Component |
|---|---|
| Component Sub-Index | Weighting |
| PBCI Natural Gas Excess Return (“LBCIPB Natural Gas”) | 10.00% |
| PBCI Crude Oil Excess Return (“LBCIPB WTI Crude”) | 5.00% |
| PBCI Brent Excess Return (“LBCIPB Brent Crude”) | 5.00% |
| PBCI Unleaded Gas Excess Return (“LBCIPB Gasoline”) | 3.00% |
| PBCI Heating Oil Excess Return (“LBCIPB Heating Oil”) | 2.00% |
| PBCI Live Cattle Excess Return (“LBCIPB Live Cattle”) | 4.00% |
| PBCI Lean Hogs Excess Return (“LBCIPB Lean Hogs”) | 2.00% |
| PBCI Wheat Excess Return (“LBCIPB Wheat”) | 4.00% |
| PBCI Corn Excess Return (“LBCIPB Corn”) | 6.00% |
| PBCI Soybeans Excess Return (“LBCIPB Soybeans”) | 7.00% |
| PBCI Soybean Oil Excess Return (“LBCIPB Soybean Oil”) | 3.00% |
| PBCI Aluminum Excess Return (“LBCIPB Aluminum”) | 7.50% |
| PBCI Copper Excess Return (“LBCIPB Copper”) | 7.50% |
| PBCI Zinc Excess Return (“LBCIPB Zinc”) | 4.00% |
| PBCI Nickel Excess Return (“LBCIPB Nickel”) | 6.00% |
| PBCI Gold Excess Return (“LBCIPB Gold”) | 9.50% |
| PBCI Silver Excess Return (“LBCIPB Silver”) | 2.50% |
| PBCI Sugar Excess Return (“LBCIPB Sugar”) | 4.00% |
| PBCI Cotton Excess Return (“LBCIPB Cotton”) | 4.00% |
| PBCI Coffee Excess Return (“LBCIPB Coffee”) | 4.00% |

Index Sponsor: Lehman Brothers Inc.

Redemption Amount: A single U.S. dollar payment on the Maturity Date equal to the principal amount of the notes multiplied by:

| | |
|---|---|
| 100% + (Basket Return × | if the Final Basket Level is greater than the |
| Upside Participation Rate) | Initial Basket Level; |
| 100% | if the Final Basket Level is equal to or less |
| | than the Initial Basket Level but greater than |
| | or equal to the Buffer Level |
| 100% + (Basket Return + | if the Final Basket Level is less than the |
| Protection Percentage) | Buffer Level |

The notes are only 20% principal protected, even if held to maturity, and you may lose a substantial part of your investment. If the Basket Return is less than the Buffer Level (that is, if the Final Basket Level has declined by more than 20.0% relative to the Initial Basket Level), you will lose principal in proportion to the percentage by which the decline in the Final Basket Level relative to the Initial Basket Level exceeds 20.0%. Accordingly, in such circumstances the Redemption Amount will be less than, and may be as little as, 20% of the principal amount invested.

Upside Participation Rate: 181.0%

Protection Percentage: 20.0%

Buffer Level: 80.0% of the Initial Basket Level

Basket Return:

$$\frac{Final Basket Level - Initial Basket Level}{Initial Basket Level}$$

expressed as a percentage (rounded to three decimal places).

Initial Basket Level: Set to 100 on the Trade Date

Final Basket Level: 100×(1+the sum of the Weighted Component Sub-Index Returns)

Weighted Component Sub-Index Returns: For each Component Sub-Index:

$$Component Weighting \times \frac{Final Index Value - Initial Index Value}{Initial Index Value}$$

Initial Index Value: For each Component Sub-Index, the Index Value of the Component Sub-Index on the Trade Date, as set forth below:

| | Initial Index |
|---|---|
| Component Sub-Index | Value |
| LBCIPB Natural Gas | 69.4364 |
| LBCIPB WTI Crude | 104.0448 |
| LBCIPB Brent Crude | 102.7882 |
| LBCIPB Gasoline | 124.8300 |
| LBCIPB Heating Oil | 94.7922 |
| LBCIPB Live Cattle | 105.4617 |
| LBCIPB Lean Hogs | 105.8668 |
| LBCIPB Wheat | 194.8825 |
| LBCIPB Corn | 134.3649 |
| LBCIPB Soybeans | 142.7296 |
| LBCIPB Soybean Oil | 140.0817 |
| LBCIPB Aluminum | 103.0509 |
| LBCIPB Copper | 122.5884 |
| LBCIPB Zinc | 108.4202 |
| LBCIPB Nickel | 197.7906 |
| LBCIPB Gold | 118.2720 |
| LBCIPB Silver | 123.2873 |
| LBCIPB Sugar | 54.4007 |
| LBCIPB Cotton | 102.9430 |
| LBCIPB Coffee | 101.0169 |

Final Index Value: For each Component Sub-Index, the Index Value of the Component Sub-Index on the Valuation Date.

Index Value: For each Component Sub-Index, the closing level of that Component Sub-Index, as determined and published by the Index Sponsor (subject to the occurrence of a Market Disruption Event or an Index Unavailability Event), rounded to four decimal places.

Market Disruption Events: If a Market Disruption Event relating to one or more Component Sub-Indices is in effect on the scheduled Valuation Date, the Calculation Agent will calculate the Final Basket Level using:
for each such Component Sub-Index that did not suffer a Market Disruption Event on the scheduled Valuation Date, the Final Index Level for that Component Sub-Index on the scheduled Valuation Date, and
for each such Component Sub-Index that did suffer a Market Disruption Event on the scheduled Valuation Date, the Final Index Level on the immediately succeeding trading day for such Component Sub-Index on which no Market Disruption Event occurs or is continuing with respect to such Component Sub-Index;

provided, however, that if a Market Disruption Event has occurred or is continuing with respect to a Component Sub-Index on each of the eight scheduled trading days following the scheduled Valuation Date, then (a) that eighth scheduled trading day shall be deemed the Valuation Date for the affected Component Sub-Index; and (b) the Calculation Agent will determine the Final Index Value for the affected Component Sub-Index on such day in good faith in accordance with the formula for and method of calculating the Component Sub-Index last in effect prior to commencement of the Market Disruption Event using a price for the Index Contract on such eighth scheduled Index Business Day determined by the Calculation Agent in its sole and absolute discretion taking into account the latest available quotation for the price of the Index Contract applicable to such Component Sub-Index and any other information that in good faith it deems relevant.

A “Market Disruption Event” for a Component Sub-Index means any of the following events, in each case as determined in good faith by the Calculation Agent:
(A) the termination or suspension of, or material limitation or disruption in the trading on the applicable Relevant Exchange of the Index Contract for that Component Sub-Index;
(B) the settlement price on the applicable Relevant Exchange of the Index Contract for that Component Sub-Index has increased or decreased by an amount equal to the maximum permitted price change from the previous day's settlement price; or
(C) the settlement price of the Index Contract for that Component Sub-Index is not published by the applicable Relevant Exchange.

Notwithstanding the foregoing, the following events will not constitute a Market Disruption Event for a Component Sub-Index:
(1) a limitation on the hours in a trading day and/or number of days of trading, if it results from an announced change in the regular business hours of the applicable Relevant Exchange of the Index Contract for that Component Sub-Index; or
(2) a decision to permanently discontinue trading in the Index Contract for that Component Sub-Index or options or futures contracts relating to that Index Contract of the related Component Sub-Index.

For purposes of the above, (a) “Index Contract” means the commodity contract then underlying each Component Sub-Index or any Successor Sub-Index; (b) “Relevant Exchange” means any organized exchange or market of trading for the Index Contract then included in the Component Sub-Index or any Successor Sub-Index; and (c) “trading day” means a day, as determined in good faith by the Calculation Agent, on which trading is generally conducted on the Relevant Exchange applicable to the Index Contract for the affected Component Sub-Index.

Index Unavailability Event: If an Index Unavailability Event for any Component Sub-Index is in effect on the scheduled Valuation Date (and no Market Disruption Event is then in effect for that Component Sub-Index), the Calculation Agent will determine the Final Index Value for the affected Component Sub-Index on the Valuation Date in good faith in accordance with the formula for and method of calculating the Component Sub-Index last in effect prior to commencement of the Index Unavailability Event, using the closing price on the Valuation Date for the Index Contract for the Component Sub-Index on the Relevant Exchange for that Index Contract.

An “Index Unavailability Event” for a Component Sub-Index means that the Component Sub-Index is not calculated and published by the Index Sponsor or any Successor Sub-Index is not calculated and published by the sponsors thereof.

Index Adjustment: If the Index Sponsor discontinues publication of a Component Sub-Index and the Index Sponsor or another entity publishes a successor or substitute index that the Calculation Agent determines, in its sole discretion, to be comparable to the discontinued Component Sub-Index (such index, a “Successor Sub-Index”), then the Final Index Value for such Component Sub-Index will be determined by reference to the level of such Successor Sub-Index at the close of trading on the Relevant Exchange or market of the Index Contract for that Successor Sub-Index on the Valuation Date; provided, however, that the Calculation Agent, in its sole discretion, may make such adjustments as it deems necessary to the level of the Successor Sub-Index so that the level of the Successor Sub-Index reflects the same level as that of the discontinued Component Sub-Index before it was discontinued. Upon any selection by the Calculation Agent of a Successor Sub-Index for any Component Sub-Index, the Calculation agent will cause written notice thereof to be promptly furnished to the trustee, to the Issuer and to the holders of the notes.

If the Index Sponsor discontinues publication of a Component Sub-Index prior to, and such discontinuation is continuing on, the Valuation Date, and the Calculation Agent determines, in its sole discretion, that no Successor Sub-Index is available at such time, then the Calculation Agent will determine the Final Index Value for such Component Sub-Index on the Valuation Date. The Final Index Value for such Component Sub-Index will be computed by the Calculation Agent in accordance with the formula for and method of calculating such Component Sub-Index last in effect prior to such discontinuation, using the settlement price of the Index Contract for such Component Sub-Index (or, if trading in such Index Contract has been materially suspended or materially limited, its good faith estimate of the settlement price that would have prevailed but for such suspension or limitation) at the close of trading on the Relevant Exchange for such Index Contract on the Valuation Date.

If at any time the method of calculating a Component Sub-Index or a Successor Sub-Index, or the level thereof, is, in the good faith judgment of the Calculation Agent, changed or modified in a material respect, the Calculation Agent may (but is not obligated to) make such adjustments to the Component Sub-Index or Successor Sub-Index or their respective methods of calculation as, in the good faith judgment of the Calculation Agent, may be necessary in order to arrive at a level of a commodity index comparable to such Component Sub-Index or Successor Sub-Index, as the case may be, as if such changes or modifications had not been made, and the Calculation Agent will calculate the Final Index Value for such Component Sub-Index or Successor Sub-Index with reference to the Component Sub-Index or Successor Sub-Index as adjusted. Accordingly, if the method of calculating a Component Sub-Index or a Successor Sub-Index is modified or rebased so that the level of such Component Sub-Index or Successor Sub-Index is a fraction or multiple of what it would have been if it had not been modified or rebased, then the Calculation Agent will adjust the level of such Component Sub-Index or Successor Sub-Index in order to arrive at a level of the Component Sub-Index or Successor Sub-Index as if it has not been modified or rebased.

Index Business Day: A day, as determined in good faith by the Calculation Agent, on which trading is generally conducted on the Relevant Exchange for each Index Contract underlying a Component Sub-Index.

Business Days: New York

Underwriter: Lehman Brothers Inc.

Calculation Agent: Lehman Brother Commodity Services Inc.

Denomination: US$10,000 and integral multiples of US$1,000

Issue Type: US MTN

Fees:

| | Price | | |
|---|---|---|---|
| | to Public⁽¹⁾ | Fees⁽²⁾ | Proceeds to the Issuer |
| Per note | $100,000 | $0.00 | $10,000 |
| Total | $144,330,000 | $0.00 | $144,330,000 |

⁽¹⁾The price to public includes Lehman Brothers Holdings Inc.'s cost of hedging its obligations under the notes through one or more of its affiliates, which include such affiliates expected cost of providing such hedge as well as the profit the such affiliates expect to realize in consideration for assuming the risks inherent in providing such hedge.
⁽²⁾Lehman Brothers Inc. and/or an affiliate may earn income as a result of payments pursuant to any hedges.

Appendix 4: Lehman Brothers Commodity Index

Lehman Brothers Inc. launched the Lehman Brothers Commodity Index (“LBCI”), which includes the LBCI Total Return and LBCI Excess Return on Jul. 1, 2006. The LBCI is a rules-based index of commodities futures that uses liquidity as the primary criterion for commodity selection and weights. The LBCI currently is composed of the prices of 20 exchange-traded futures contracts (the “Index Contracts”) on physical commodities. A futures contract is a bilateral agreement providing for the purchase and sale of a specified type and quantity of a commodity or financial instrument during a stated delivery month for a fixed price. The commodities currently included in the LBCI are: crude oil, heating oil, natural gas, unleaded gas, aluminum, copper, nickel, zinc, gold, silver, lean hogs, live cattle, corn, soybean, soybean meal, soybean oil, wheat, coffee, cotton and sugar.

The LBCI contains four major sectors: energy, metals, agriculture, and livestock. Within metals, there are additional sub-sectors for industrial metals and precious metals. Within agriculture there are sub-sectors for grains and softs. Each of these sector indices represents the liquidity weighted returns of its commodity components.

The LBCI Total Return is a total return index, reflecting the combined returns associated with the changes in price of the underlying Index Contracts together with the “roll yields” for those Index Contracts (together, the “excess return”), together with the interest return on a hypothetical fully collateralized investment in the Index Contracts. The LBCI Excess Return, by contrast, is an excess return index, reflecting the excess return associated with the underlying Index Contracts without any return on collateral. For a description of calculation of the excess return and total return, see below. Lehman Brothers Inc. also developed and calculated a number of sub-indices representing components of the LBCI, as well as certain variations of the LBCI or its sub-indices reflecting weightings of the component Index Contracts that are different from the annual weighting assignments of the LBCI generally (or the sub-indices of the LBCI).

The LBCI, including the LBCI Total Return, the LBCI Excess Return, each

LBCI sub-index and any variations of the LBCI or its sub-indices, is a proprietary index that Lehman Brothers Inc. developed and calculates.

An “LBCI Business Day” will follow the New York Mercantile Exchange (NYMEX) holiday calendar and the LBCI will only be published on days when the NYMEX is open for trading (including half days). On those days when any other exchange (LME, CBOT, CME, and NYBOT) is closed and the NYMEX is open, Lehman Brothers Inc. will use data for the affected Index Contract(s) from the previous available business day on which such exchange(s) was open for LBCI calculations. On days when the NYMEX is closed and other exchanges are open, returns will be reflected on the next day when the NYMEX is open. Contract roll schedules will reflect the NYMEX calendar for all commodities. If there is a NYMEX holiday before or during a roll period, the scheduled roll will be pushed forward to the next LBCI Business Day.

Commodity Selection and Weights

LBCI composition and weights are reset annually each January to reflect updated historical commodity contract liquidity data as of November 30 of the previous year. In addition, the projected liquidity factors and LBCI weights may be calculated and published throughout the year using the trailing three-year average daily volume as of that day. This timeframe enables the LBCI to be constructed using more recent liquidity data while still giving investors sufficient time to prepare for the LBCI rebalancing.

Quantifying Commodity Liquidity

The LBCI components are both selected and weighted based on historical commodity futures liquidity. For LBCI purposes, liquidity is derived from the exchange reported trading volume of non-financial commodities futures. To make a meaningful comparison across commodity markets, a trailing three-year average of the average daily dollar volume of contracts traded (DVCT) is calculated for all commodities that may be eligible for the LBCI. Converting published volumes from each of the exchanges into a daily dollar value allows for direct comparisons of liquidity across exchanges in a common metric. Daily calculations over a three-year period capture intra-month liquidity changes while offering a historical perspective that reflects the seasonality and cyclicality of different markets and maintains LBCI stability.

For each commodity a DVCT is calculated using the following steps:

1. Identify contract-specific trading volumes and closing prices as reported daily by each global futures exchange. All futures expirations of a standardized contract with trading activity are included in the calculation. If volumes are not published for specific settlement dates in the future, the aggregated volumes published for each contract are used across all settlement dates.

2. To derive the DVCT of a contract: multiply the closing price of that contract times (A) the daily reported trading volume of that contract and (B) the fixed number of units in which each contract is denominated.

3. Aggregate the daily values derived in step 2 for all settlement dates of that contract to determine the summed daily dollar volume traded for the entire commodity contract.

4. Average the daily dollar volume traded in step 3 over the trailing three-year period to calculate a trailing three-year average daily DVCT.

Selecting Commodities for the LBCI Based on Liquidity

To be eligible for the LBCI, a commodity must meet a minimum liquidity threshold based on trading volume in the past three years. Commodity liquidity is evaluated across all contracts and settlement dates on the various global commodity futures exchanges for commodities that may be eligible for the LBCI.
Commodities with an average daily dollar trading volume exceeding $250 million over the previous three years as of November 30 are eligible for inclusion in the LBCI (except industrial metals traded on the London Metals Exchange (LME), which will require a minimum average daily trading volume of $1 billion because of differences in their method for reporting volumes compared with other exchanges).
LBCI-eligible commodities will remain in the LBCI until their average daily dollar volume traded over the previous three years as of November 30 drops below $200 million ($800 million for LME metals). This will help maintain LBCI compositional stability and prevent commodities from exiting the LBCI for a year just to re-enter at the beginning of the next year if they are at or near the $250 million ($1 billion) threshold.
Only the largest contract per commodity based on liquidity will be LBCI-eligible. For example, the largest crude oil contract, West Texas Intermediate Crude Oil, which trades on the NYMEX, will be the Index Contract for crude oil while Brent Crude, which trades on the Inter Continental Exchange (ICE), will not, despite the fact that both contracts meet the LBCI liquidity requirement.
If the LBCI-eligible contract of a particular commodity is discontinued or substituted in the market by a different contract as a result of external factors such as government regulations, the new contract may be substituted as the Index Contract in between LBCI rebalancing dates after providing advanced notice to LBCI users.
Commodities that are considered to be derivatives or downstream products created from other LBCI-eligible commodities are treated as separate commodities as long as they have sufficient market liquidity and are evaluated for LBCI eligibility on a stand-alone basis. For example, soybeans, soybean meal, and soybean oil are treated as separate commodities and will each be LBCI-eligible if their respective liquidity exceeds $250 million daily. The same holds true for crude oil and its downstream products of heating oil and unleaded gasoline.
Only U.S. dollar-denominated contracts are currently LBCI-eligible. Alternate versions of the LBCI that may substitute or add non-U.S. dollar contracts are planned for future development.
The LBCI contains 20 commodities that qualified for inclusion, each with its single associated Index Contract (see Table 18 below). Commodities that did not meet the minimum liquidity threshold but are represented in other major indices include cocoa, lead, and feeder cattle.

TABLE 18
LBCI Eligible Commodities and Contracts for 2007

| | | | | USD Denominated |
|---|---|---|---|---|
| | | | | Futures Contracts |
| | | | | Greater than |
| | | | | $250m DVCT |
| | Contract | | | Not Currently |
| Commodity | Used in LBCI | Exchange | Ticker | Eligible for LBCI |
| Crude Oil | West Texas | NYMEX | CL | Brent Crude (IPE) |
| | Intermediate | | | |
| Heating Oil | Heating Oil | NYMEX | HO | Gasoil (IPE) |
| Natural Gas | Henry Hub | NYMEX | NG | |
| Unleaded | RBOB | NYMEX | XB | HU RFG (used prior |
| Gas | | | | to Jul. 1, 2006) |
| Aluminum | High Grade | LME | LA | Alloy (LME), |
| | Aluminum | | | Aluminum |
| | (London) | | | (COMEX) |
| Copper | Copper | LME | LP | Copper (COMEX) |
| | (London) | | | |
| Nickel | Primary Nickel | LME | LN | |
| | (London) | | | |
| Zinc | High Grade | LME | LX | |
| | Zinc (London) | | | |
| Gold | Gold (New | COMEX | GC | Gold (CBOT) |
| | York) | | | |
| Silver | Silver (New | COMEX | SI | Silver (CBOT) |
| | York) | | | |
| Lean Hogs | Lean Hogs | CME | LH | |
| Live Cattle | Live Cattle | CME | LC | |
| Corn | Corn | CBOT | C | |
| Soybean | Soybean | CBOT | S | |
| Soybean | Soybean Meal | CBOT | SM | |
| Meal | | | | |
| Soybean Oil | Soybean Oil | CBOT | BO | |
| Wheat | Wheat | CBOT | W | Kansas (KCBOT), |
| | (Chicago) | | | Minneapolis (MGE) |
| Coffee | Coffee ‘C’ | NYBOT | KC | Arabica (BMF), |
| | | | | Robusta (LIFFE) |
| Cotton | Cotton No. 2 | NYBOT | CT | |
| Sugar | Sugar No. 11 | NYBOT | SB | Sugar No. 14 |
| | | | | (NYBOT) |

Source: Lehman Brothers Inc., 2007

Commodity Weightings

Once the list of LBCI-eligible contracts has been determined, each commodity will be re-weighted in the LBCI at the start of each year (implemented during the January roll period) using its average daily liquidity as of the previous November month-end. Average daily liquidity as of November 30 is converted into a commodity liquidity factor (based on contract closing prices as of the second LBCI Business Day of the year) that is held constant for each commodity after the January roll period. Though the liquidity factor remains constant, daily LBCI weightings will adjust throughout the year with the price movements of the underlying Index Contracts (i.e., price appreciation in an Index Contract will increase the weight of that Index Contract in the LBCI).
Each Index Contract will be weighted in the LBCI in proportion to its liquidity relative to the other Index Contracts. Volumes for Index Contracts traded on the LME are divided by two to more accurately reflect the liquidity of the metals represented by these Index Contracts relative to other LBCI-eligible commodities.
If a commodity does not have liquidity data for the full three-year period as of November month-end, average daily liquidity will be used for the data points that do exist, provided that the time series is longer than one year. If an Index Contract was substituted for a different Index Contract for that commodity, the previous Index Contract's historical liquidity may also be considered to determine LBCI weights for that commodity.
There will be no caps or floors on a particular commodity or sector weighting based on liquidity.
LBCI weights will be published daily. In addition, projected LBCI weights for the following year are calculated using the trailing three-year average daily volume as of that day. On November 30, this projected weight will become the initial weight for the following year. Table 19 below shows the evolution of commodity and sector LBCI weights since 2001.

Calculating Commodity Liquidity Factors and LBCI Weights

The two components used to calculate a commodity's daily LBCI weight are its liquidity factor and the price of the relevant Index Contract. While a commodity's Index Contract price changes daily based on movements in the futures markets, its liquidity factor, or “amount outstanding”, is reset only once a year based on its trailing three-year historical contract liquidity.

The liquidity factor is a derived number equivalent to the relative amount of each commodity needed to achieve the liquidity-based weightings set forth by the LBCI rules. It is not a direct measure of trading volume or market liquidity. It is calculated by dividing the average daily dollar value of contracts traded as of November 30 of the previous year (which determines the beginning of year LBCI weights) by the closing prices of each Index Contract as of the second LBCI Business Day of the new calendar year. For a given commodity contract, the formula for liquidity factor is:

$$Liquidity Factor = \frac{{DVCT}_{Prev Nov ME}}{{Price}_{2 nd Business Day}}$$

Where: DVCT_{Prey Nov ME,i}=Trailing three-year average dollar value of contracts traded for LBCI eligible contract i as of November 30 of the previous year.
Price_{2nd Business Day}=Prompt contract closing price of Index Contract for commodity i, as of the second LBCI Business Day of the year.

Rebalancing Liquidity Factors

Annual LBCI rebalancing is implemented during the January LBCI roll period. This occurs by switching from the previous year's liquidity factor to the current year's liquidity factor in 20% daily increments during the five-day roll period. Rebalancing over a five-day roll period maintains LBCI stability by not causing a major LBCI re-weighting on a single LBCI Business Day. Liquidity factors for each year will be announced at the end of the second LBCI Business Day of that year.

On the first through fifth LBCI Business Day of each year, the liquidity factor for each commodity will be the previous year's liquidity factor. On the sixth through ninth LBCI Business Days of the January roll period, the liquidity factor will be a weighted combination of the previous year's and current year's liquidity factors. From the tenth LBCI Business Day forward, the LBCI will use the current year's liquidity factor. Once 100% of the new liquidity factor is used for LBCI weightings, the annual rebalancing has been completed. Daily LBCI weights will then reflect both the rebalanced component weights and the daily price movements that have since occurred.

The following two tables (Tables 19 and 20) show the hypothetical yearly initial weights for the LBCI, which was launched on Jul. 1, 2006, over the period starting from Jan. 1, 2001 until Jul. 1, 2006, and actual initial LBCI weights as of Jul. 1, 2006, as well as the daily weightings for the LBCI at Jul. 31, 2007. Neither the daily weightings nor the hypothetical and actual historical initial weights presented below are necessarily indicative of the future initial or daily weightings of any particular Index Contract, commodity or sector in the LBCI.

TABLE 19

| | | | Initial Annual LBCI Weights (as of January 1, unless otherwise specified) | | | | | | | |
|---|---|---|---|---|---|---|---|---|---|---|
| Sector & Commodity Selection | | | | Jul. 1, | | | | | | |
| Sector/Commodity | Contract | Exch. | 2007 | 2006 | 2006 | 2005 | 2004 | 2003 | 2002 | 2001 |
| Energy | | | 55.85% | 51.02% | 56.17% | 52.12% | 51.21% | 50.77% | 46.81% | 40.31% |
| Crude Oil | West Texas | NYM | 29.04% | 27.48% | 26.65% | 23.49% | 22.19% | 22.38% | 20.81% | 17.67% |
| Natural Gas | Henry Hub | NYM | 13.28% | 7.98% | 14.63% | 15.06% | 15.91% | 15.27% | 13.74% | 11.99% |
| Unleaded | NY | NYM | 6.11% | 8.13% | 7.54% | 7.05% | 6.84% | 6.79% | 6.27% | 5.38% |
| Gas | | | | | | | | | | |
| Heating Oil | No. 2 Heating | NYM | 7.42% | 7.43% | 7.35% | 6.52% | 6.28% | 6.33% | 5.99% | 5.28% |
| Metals | | | 25.51% | 30.10% | 22.77% | 24.47% | 25.24% | 26.19% | 28.92% | 32.13% |
| Industrial | | | 16.91% | 20.11% | 14.12% | 16.08% | 18.12% | 20.25% | 22.19% | 23.84% |
| Metals | | | | | | | | | | |
| Aluminum | High Grade | LME | 5.10% | 4.54% | 4.29% | 6.11% | 8.10% | 9.12% | 9.65% | 9.94% |
| | Aluminum | | | | | | | | | |
| Copper | Copper-Grade | LME | 8.10% | 10.50% | 6.68% | 6.78% | 6.95% | 7.52% | 8.25% | 8.71% |
| Nickel | Primary Nickel | LME | 1.60% | 2.23% | 1.55% | 1.58% | 1.48% | 1.83% | 2.21% | 2.70% |
| Zinc | Special High | LME | 2.12% | 2.83% | 1.60% | 1.60% | 1.59% | 1.78% | 2.09% | 2.49% |
| Precious Metals | | | 8.60% | 10.00% | 8.64% | 8.40% | 7.11% | 5.94% | 6.73% | 8.29% |
| Gold | Gold | CMX | 6.63% | 7.65% | 6.83% | 6.70% | 5.67% | 4.49% | 4.88% | 5.83% |
| Silver | Silver | CMX | 1.97% | 2.34% | 1.81% | 1.70% | 1.44% | 1.45% | 1.85% | 2.46% |
| Agricultural | | | 15.8% | 16.54% | 18.22% | 20.55% | 20.35% | 19.75% | 20.66% | 23.97% |
| Grains | | | 12.14% | 13.40% | 14.62% | 17.17% | 17.01% | 16.17% | 16.30% | 18.36% |
| Soybeans | Soybeans | CBT | 5.19% | 5.76% | 6.88% | 7.89% | 7.31% | 6.59% | 6.73% | 7.88% |
| Corn | Corn | CBT | 2.99% | 3.24% | 3.06% | 3.66% | 3.83% | 3.98% | 3.98% | 4.34% |
| Soybean | Soybean Meal | CBT | 1.37% | 1.48% | 1.86% | 2.30% | 2.38% | 2.30% | 2.28% | 2.37% |
| Meal | | | | | | | | | | |
| Wheat | Chicago | CBT | 1.64% | 1.73% | 1.60% | 1.86% | 2.03% | 2.02% | 2.00% | 2.04% |
| Soybean Oil | Soybean Oil | CBT | 0.95% | 1.18% | 1.21% | 1.47% | 1.45% | 1.28% | 1.31% | 1.73% |
| Softs | | | 3.63% | 3.14% | 3.61% | 3.38% | 3.34% | 3.58% | 4.36% | 5.61% |
| Coffee | Coffee “C” | NYBOT | 1.36% | 1.16% | 1.43% | 1.27% | 1.15% | 1.30% | 1.76% | 2.31% |
| Cotton | Cotton #2 | NYBOT | 0.90% | 0.95% | 1.11% | 1.20% | 1.27% | 1.28% | 1.53% | 2.08% |
| Sugar | World Sugar | NYBOT | 1.37% | 1.03% | 1.06% | 0.90% | 0.92% | 1.00% | 1.07% | 1.22% |
| Livestock | | | 2.87% | 2.34% | 2.84% | 2.86% | 3.21% | 3.30% | 3.60% | 3.59% |
| Live Cattle | Live Cattle | CME | 1.82% | 1.43% | 1.88% | 1.99% | 2.35% | 2.33% | 2.49% | 2.48% |
| Lean Hogs | Lean Hogs | CME | 1.05% | 0.91% | 0.96% | 0.87% | 0.86% | 0.97% | 1.11% | 1.11% |
| | | Total | 100% | 100% | 100% | 100% | 100% | 100% | 100% | 100% |

Source: Lehman Brothers Inc., 2007
(1) NY Harbor RFG Contract used until Jul. 1, 2006; RBOB contract used thereafter.

TABLE 20
LBCI Daily Weights at Sep. 30, 2007

| Sector & Commodity Selection | | | Daily LBCI |
|---|---|---|---|
| Sector/ | | | Weights at |
| Commodity | Contract | Exch. | Sep. 30, 2007 |
| Energy | | | 58.99% |
| Crude Oil | West Texas Intermediate | NYM | 32.88% |
| Natural Gas | Henry Hub Natural Gas | NYM | 11.41% |
| Unleaded Gas | NY Harbor/RBOB (1) | NYM | 6.46% |
| Heating Oil | No. 2 Heating Oil NY | NYM | 8.24% |
| Metals | | | 22.46% |
| Industrial Metals | | | 14.69% |
| Aluminum | High Grade Primary | LME | 3.61% |
| | Aluminum | | |
| Copper | Copper - Grade A | LME | 8.80% |
| Nickel | Primary Nickel | LME | 1.07% |
| Zinc | Special High Grade Zinc | LME | 1.21% |
| Precious Metals | | | 7.77% |
| Gold | Gold | CMX | 6.12% |
| Silver | Silver | CMX | 1.65% |
| Agricultural | | | 16.20% |
| Grains | | | 13.35% |
| Soybeans | Soybeans | CBT | 5.87% |
| Corn | Corn | CBT | 2.37% |
| Soybean Meal | Soybean Meal | CBT | 1.54% |
| Wheat | Chicago | CBT | 2.54% |
| Soybean Oil | Soybean Oil | CBT | 1.03% |
| Softs | | | 2.85% |
| Coffee | Coffee “C” | NYBOT | 1.08% |
| Cotton | Cotton #2 | NYBOT | 0.82% |
| Sugar | World Sugar #11 | NYBOT | 0.95% |
| Livestock | | | 2.35% |
| Live Cattle | Live Cattle | CME | 1.52% |
| Lean Hogs | Lean Hogs | CME | 0.84% |
| | | Total | 100.00% |

Source: Lehman Brothers Inc., 2007

Introducing and Removing Commodities

As time progresses the LBCI will experience some turnover in the list of eligible commodity contracts. If a new contract becomes eligible or ceases to be eligible at the end of November based upon trailing three-year daily average liquidity, then it will enter or exit during the January weighting roll period.

LBCI Return Calculations

Types and Sources of LBCI Returns from Long Futures Positions

A long position in a commodity futures contract generates returns from change in the spot price of the commodity, roll yield and collateral interest. Accordingly, three main types of returns are calculated for the LBCI:
Spot return—the returns associated with the percentage of the underlying Index Contracts used to price the LBCI before any contract rolling has occurred.
Excess return—the combined returns associated with the changes in price of the underlying Index Contracts together with the “roll yields” for those Index Contracts; and
Total return—the excess return plus the return on the collateral that has to be posted as margin against the futures positions.

Both excess and total returns on the LBCI and its components are calculated on a daily basis.

Spot Returns

Spot returns, which reflect changes in commodity spot prices, are fairly straightforward. If the LBCI is long wheat and the spot price of wheat appreciates then a positive return will accrue. Thus, on any LBCI Business Day in a month other than a day during a roll period for an Index Contract, or in a month in which no roll is scheduled to occur for that Index Contract, the level of the LBCI will reflect the increase or decrease (in proportion to the relative weighting of the Index Contracts in the LBCI) in the price of each then active (prompt) Index Contract relative to the previous day's closing price for that prompt Index Contract.

Excess Returns

The “excess returns” of the LBCI are the combined return of spot price movements and “roll yield” associated with the rolling of Index Contracts. The roll yield generated depends on the pricing of longer-dated futures contracts relative to nearby futures and spot commodity prices. When longer-dated contracts are priced lower than the nearer contract and spot prices, the market is in backwardation. When the opposite is true and longer contracts are priced higher, the market is in contango. Positive roll yield is generated in backwardated markets when higher priced spot or near-term futures contracts are “sold” to “buy” lower priced longer-dated contracts. Negative roll yield occurs in contangoed markets when lower priced spot or near-term futures contracts are “sold” to “buy” higher priced longer-dated contracts. Accordingly, when the market for an Index Contract is in backwardation, the roll yield for a month in which that Index Contract is rolled will be positive and therefore serve to increase the level of the LBCI relative to what it would have been based solely on the spot price movements in the Index Contract. Conversely, when the market for an Index

Contract is in contango, the roll yield for a month in which that Index Contract is rolled will be negative and therefore will decrease the level of the LBCI.

Total Returns

The third source of return from a long futures position comes from collateral posted as margin. A fully collateralized futures position posts the full investment as margin, which is then invested in money market or other similar cash instruments that generate a return. For the LBCI, total returns are calculated by adding a Treasury Bill return (compounded daily) to the excess returns described above to represent the total return earned by a fully collateralized futures position.

Daily Treasury Bill returns are compounded from the previous LBCI Business

Day. If the current LBCI Business Day is more than one calendar day from the previous LBCI Business Day, the Treasury Bill return will be calculated and compounded for those additional days. For each calendar day during the Index calculation period, collateral will earn a daily Treasury Bill return as specified below. If there is more than one calendar day in the calculation period this return will be compounded for the number of days in the period.

$$3 \text{-} Month Treasury Bill Return Daily = \frac{{( 1 )}^{1 / 91}}{1 - ( 91 / 360 ) * {HR}_{t - 1}}$$

Where HRₜ₋₁=for any LBCI Business Day, the 91-day auction high rate for U.S. Treasury Bills announced by the U.S. Department of the Treasury and reported under the heading “High Rate” on Telerate page 56, or any successor page, on the most recent of the weekly auction dates prior to such LBCI Business Day. The high rate is generally available on Monday afternoons (if not a holiday), and as a result the high rate for each week will generally first be used in that weeks's return calculations beginning on Tuesday.

Commodity Roll Mechanics

A fundamental characteristic of the LBCI, like other commodity indices, is that as a result of being comprised of futures contracts, the LBCI has to be managed to ensure it does not take delivery of the commodities in question. This is achieved through the commodity roll mechanics under which the Index Contracts underlying the LBCI are rolled forward to a new contract date during the month as they approach their settlement date. Therefore, at the contract level, there are up to two Index Contracts that can contribute to LBCI returns during the month: the prompt (nearby) contract and the prompt +1 (next nearby) contract into which it is rolled.

During any month in which an the Index Contract is scheduled to roll, the roll period will begin at the end of the fifth LBCI Business Day in that month and last for five LBCI Business Days. During the roll period, the hypothetical position in the Index Contract is gradually shifted from the prompt Index Contract to the prompt +1 Index Contract (i.e., the Index Contract with the next nearest expiration) in 20% daily increments. The daily price of the Index Contract during the roll period, as well as the previous day's price of the Index Contract against which the appreciation or depreciation of the daily Index Contract price is measured, therefore will each be a composite price of the then-current prompt Index Contract and the prompt +1 Index Contract weighted by the percentage that has been rolled at the end of the previous LBCI Business Day. Accordingly, during the roll period for a given Index Contract, the returns for that Index Contract are calculated as follows:
On the fifth LBCI Business Day of the relevant month, Index Contract excess returns will reflect 100% of the price movements of the prompt contract. At the end of that fifth LBCI Business Day, 20% of the prompt contract will be rolled to the prompt +1.
At the beginning of the sixth LBCI Business Day in that month, the excess returns on the Index Contract will reflect a contract “basket” containing 80% of the prompt contract and 20% of the prompt +1 at the start of that day. Excess returns will be calculated on this “basket”. At the end of that sixth LBCI Business Day, an additional 20% is rolled.
For the seventh LBCI Business Day, the “basket” will consist of 60% prompt/40% prompt +1.
For the eighth LBCI Business Day, the “basket” will consist of 40% prompt/60% prompt +1.
For the ninth LBCI Business Day, the “basket” will consist of 20% prompt/80% prompt +1.
At the end of the ninth LBCI Business Day of the relevant month, the prompt contract will have been fully rolled into the prompt +1, which then becomes the new prompt until the next roll period.

Returns on an Index Contract on and after the tenth LBCI Business Day in a month in which it is rolled will comprise 100% of the new prompt contract that has just been fully rolled into (which was formerly the prompt +1 at the start of that month).

Adjustments to the Contract Roll Process

A number of market circumstances can lead to an adjustment in the rolling process. These adjustments occur when it would be difficult to liquidate or establish positions in the market and perform the roll. If any of these market disruption events occurs on any of the days during the roll period, then the proportion of the roll that would have taken place on that day is skipped. For example, if a market disruption event occurs on the first day of the roll, then none of the 80%/20% roll is taken. Instead the 60%/40% proportion is taken on the next LBCI Business Day. If a market disruption event occurs on that day also, then the roll proportion will be 40%/60% on the following LBCI Business Day. Two examples of disruption events are:
Commodity reaches a limit price during the last 15 minutes of the trading session—if either the prompt or prompt +1 contract reaches a limit price during the final 15 minutes of regular or rescheduled trading, the roll will be skipped that day.
Trading interrupted or terminated on an exchange—if trading is terminated prior to the expected close of business and does not resume at least 15 minutes prior to the scheduled close, then the roll will be deferred.

If either event occurs, a notice will be posted indicating the event and reason.

LBCI Contract Calendar

The LBCI Contract Calendar specifies which Index Contracts (by settlement month) are used to calculate LBCI returns for each monthly reporting period. For each calendar month, the LBCI Contract Calendar indicates a prompt contract and, if a given Index Contract is scheduled to be rolled during the month, the prompt +1 contract. If a roll is not scheduled, then only the prompt contract is listed (and LBCI returns are calculated solely be reference to the prompt contract). Contracts are selected to ensure there is sufficient market liquidity in each commodity when calculating LBCI returns. Monthly contracts for a given commodity that are less liquid and have significantly lower trading volumes relative to other settlement months will be excluded from the LBCI Contract Calendar, and will not be rolled into or included in commodity price calculations. Appendix 5 shows the LBCI Contract Calendar for 2007, indicating the prompt contracts and, where applicable, the prompt +1 contracts, for each Index Contract in each calendar month. The LBCI Contract Calendar for each succeeding year will be published annually.

APPENDIX 5
2007 LBCI Contract Calendar

| | | | Current Active Contract/Next Active Contract | | | | | |
|---|---|---|---|---|---|---|---|---|
| | | | by LBCI Reporting Month | | | | | |
| | | | | January | February | March | April | May |
| Commodity | Contract | Exchange | Ticker | (F) | (G) | (H) | (J) | (K) |
| Crude | West Texas | NYMEX | CL | G/H | H/J | J/K | K/M | M/N |
| Oil | Intermediate | | | | | | | |
| Heating Oil | Heating Oil | NYMEX | HO | G/H | H/J | J/K | K/M | M/N |
| Natural Gas | Henry Hub | NYMEX | NG | G/H | H/J | J/K | K/M | M/N |
| Unleaded | NYH RBOB | NYMEX | XB | G/H | H/J | J/K | K/M | M/N |
| Gas | | | | | | | | |
| Aluminum | High Grade | LME | LA | G/H | H/J | J/K | K/M | M/N |
| | Aluminum | | | | | | | |
| Copper | Copper | LME | LP | G/H | H/J | J/K | K/M | M/N |
| Nickel | Primary Nickel | LME | LN | G/H | H/J | J/K | K/M | M/N |
| Zinc | High Grade | LME | LX | G/H | H/J | J/K | K/M | M/N |
| | Zinc | | | | | | | |
| Gold | Gold (New | COMEX | GC | G/J | J | J/M | M | M/Q |
| | York) | | | | | | | |
| Silver | Silver (New | COMEX | SI | H | H/K | K | K/N | N |
| | York) | | | | | | | |
| Lean Hogs | Lean Hogs | CME | LH | G/J | J | J/M | M | M/N |
| Live Cattle | Live Cattle | CME | LC | G/J | J | J/M | M | M/Q |
| Corn | Corn | CBOT | C | H | H/K | K | K/N | N |
| Soybean | Soybean | CBOT | S | H | H/K | K | K/N | N |
| Soybean | Soybean Meal | CBOT | SM | H | H/K | K | K/N | N |
| Meal | | | | | | | | |
| Soybean Oil | Soybean Oil | CBOT | BO | H | H/K | K | K/N | N |
| Wheat | Wheat | CBOT | W | H | H/K | K | K/N | N |
| | (Chicago) | | | | | | | |
| Coffee | Coffee ‘C’ | NYBOT | KC | H | H/K | K | K/N | N |
| Cotton | Cotton No. 2 | NYBOT | CT | H | H/K | K | K/N | N |
| Sugar | Sugar No. 11 | NYBOT | SB | H | H/K | K | K/N | N |

| | Current Active Contract/Next Active Contract | | | | | | | |
|---|---|---|---|---|---|---|---|---|
| | by LBCI Reporting Month | | | | | | | |
| | | | | | | | | Ex- |
| | | | Au- | Septem- | Octo- | Novem- | Decem- | cluded |
| | June | July | gust | ber | ber | ber | ber | Con- |
| Commodity | (M) | (N) | (Q) | (U) | (V) | (X) | (Z) | tracts |
| Crude | N/Q | Q/U | U/V | V/X | X/Z | Z/F | F/G | |
| Oil | | | | | | | | |
| Heating Oil | N/Q | Q/U | U/V | V/X | X/Z | Z/F | F/G | |
| Natural Gas | N/Q | Q/U | U/V | V/X | X/Z | Z/F | F/G | |
| Unleaded | N/Q | Q/U | U/V | V/X | X/Z | Z/F | F/G | |
| Gas | | | | | | | | |
| Aluminum | N/Q | Q/U | U/V | V/X | X/Z | Z/F | F/G | |
| Copper | N/Q | Q/U | U/V | V/X | X/Z | Z/F | F/G | |
| Nickel | N/Q | Q/U | U/V | V/X | X/Z | Z/F | F/G | |
| Zinc | N/Q | Q/U | U/V | V/X | X/Z | Z/F | F/G | |
| Gold | Q | Q/Z | Z | Z | Z | Z/G | G | V |
| Silver | N/U | U | U/Z | Z | Z | Z/H | H | F |
| Lean Hogs | N/Q | Q/V | V | V/Z | Z | Z/G | G | K |
| Live Cattle | Q | Q/V | V | V/Z | Z | Z/G | G | K, N |
| Corn | N/U | U | U/Z | Z | Z | Z/H | H | |
| Soybean | N/X | X | X | X | X/F | F | F/H | Q, U |
| Soybean | N/Z | Z | Z | Z | Z/F | F | F/H | V, Q |
| Meal | | | | | | | | |
| Soybean Oil | N/Z | Z | Z | Z | Z/F | F | F/H | V, Q |
| Wheat | N/U | U | U/Z | Z | Z | Z/H | H | |
| Coffee | N/U | U | U/Z | Z | Z | Z/H | H | |
| Cotton | N/Z | Z | Z | Z | Z | Z/H | H | V |
| Sugar | N/V | V | V | V/H | H | H | H | |

Source: Lehman Brothers, 2007.
Notes:
Each month that a commodity has two letters listed will have the prompt contract rolled to the prompt +1 contract for that commodity. Using Crude Oil as an example, the prompt contract at the start of the January is the G (February) contract and the prompt +1 contract is the H (March) contract. From the fifth through the ninth LBCI Business Day, 20% of the G contract will be rolled daily into the H contract.
If a commodity only has one letter listed for an LBCI Reporting Month, there will be no contract roll that month. For example, during February, the prompt gold contract is the J (April) contract. It will not be rolled during the month.
Prior to Jul. 1, 2006, the active Unleaded Gas Contract was the RFG (Ticker: HU) contract. As of Jul. 1, 2006, the active contract is the RBOB (Ticker: XB).

1. A system comprising:
memory operable to store at least one program; and
at least one processor communicatively coupled to the memory, in which the at least one program, when executed by the at least one processor, causes the at least one processor to:
select one or more exchange-traded futures contracts on physical commodities for inclusion in an index;
identify, on aperiodic basis, for further inclusion in said index, one or more deferred futures contracts into which said selected one or more futures contracts will roll;
calculate a daily weight for each of said futures contracts included in said index; and
construct said index based on said steps of selection, identification and calculation.

2. (canceled)

3. A system as in claim 1, wherein said daily weight is based on one or more excess return values and one or more liquidity factors.

4. A system as in claim 3, wherein said daily weight is based on a product of a liquidity factor and an excess return, divided by a sum of products of liquidity factors and excess returns.

5. A system as in claim 1, wherein said identification is based on data comprising an effective spot price.

6. A system as in claim 1, wherein said processor is further caused to select forward allocations for said selected futures contracts based on data comprising an effective spot price.

7. A system as in claim 6, wherein said effective spot price is based on futures contracts looking 12 months forward.

8. A system as in claim 6, wherein said effective spot price is based on an open interest weighted average price of futures contracts within a 12 month forward allocation window.

9. A system as in claim 3, wherein one of said one or more excess return values is derived for each of a plurality of forward allocations.

10. A system as in claim 9, wherein said one of said one or more excess return values is derived for each of said plurality of forward allocations based on a roll calendar.

11. A system as in claim 9, wherein said processor is further caused to calculate an effective spot price return.

12. A system as in claim 11, wherein said processor is further caused to calculate a correlation between said effective spot price return and each of said plurality of forward allocations, to obtain a plurality of correlations, wherein each of said plurality of forward allocations is a quarterly value.

13. A system as in claim 12, wherein said processor is further caused to calculate a forward allocation based on said plurality of correlations.

14. A system as in claim 1, wherein said index is a sub-index based on a single commodity.

15. A system as in claim 14, wherein said processor is further caused to select one or more of said futures contracts for inclusion in a basket of one or more sub-indices, each sub-index based on a single commodity.

16. A system as in claim 15 further comprising a note linked to said basket of one or more sub-indices.

17-42. (canceled)

43. A system as in claim 1 further comprising a derivative product linked to said index.
